(19) United States
(12) Patent Application Publication
(10) Pub. No.: US 2025/0042032 A1
(43) Pub. Date: Feb. 6, 2025

(54) ENFORCING ROBOTIC SAFETY CONSTRAINTS BASED ON AI GENERATED SAFETY DESCRIPTIONS

(71) Applicant: 3Laws Robotics Inc., Pasadena, CA (US)

(72) Inventors: Andrew W. Singletary, Pasadena, CA (US); Ivan Jimenez, Pasadena, CA (US); Aaron D. Ames, Pasadena, CA (US)

(21) Appl. No.: 18/507,020

(22) Filed: Nov. 10, 2023

Related U.S. Application Data
(60) Provisional application No. 63/516,839, filed on Jul. 31, 2023.

(51) Int. Cl. B25J 9/16

(52) U.S. Cl. CPC B25J 9/1676; B25J 9/1658

(57) ABSTRACT

Methods, systems, and computer program products for robot safety. Multiple computer-implemented components are operatively interconnected to carry out operations for ensuring safe execution of robotic commands. Upon receiving a description (e.g., in text form or as an image) of an environment, and based on the description, forming a large language model (LLM) prompt that is provided to an artificial intelligence entity. After prompting the artificial intelligence entity, and upon receiving an LLM response that contains information about how to operate and/or constrain the robot, then guaranteeing safe operation of the robot by classifying aspects of the LLM response, labeling at least some parts of the LLM response, and then, based on the labeling, generating modified planning or control signals that ensure safe operation of the robot. Only the modified signals that ensure safe operation or other signals that are deemed to be safe are provided to the robot.

### RELATED APPLICATIONS

The present application claims the benefit of priority to U.S. Patent Application Ser. No. 63/516,839 titled “ROBOTIC SIGNAL SUPERVISOR FOR SAFETY GUARANTEES” filed on Jul. 31, 2023, which is hereby incorporated by reference in its entirety.

### TECHNICAL FIELD

This disclosure relates to robot automation, and more particularly to techniques for ensuring safe execution of AI-generated robotic commands. This disclosure presents advanced techniques that utilize generative artificial intelligence (GAI) to generate safety-related semantics pertaining to ensuring safe robotic operation in dynamically-changing environments.

### BACKGROUND

The state of machine learning had advanced to the point where even casual observers have access to technologically advanced machine learning models (e.g., large language models (LLMs)). Across a wide swath of technical endeavors, engineers and, in some cases, marketeers are wrestling with how LLMs (e.g., ChatGPT and other generative AI entities) and corresponding interfaces (e.g., conversational exchanges, application programming interfaces (APIs) etc.) can be used to ease the burden placed on human users when the users want to convert natural language statements (e.g., commands, objectives, mission statements, etc.) into a series of precise and interrelated steps. In certain domains corresponding to certain endeavors, LLMs are able to “break it down” into easily understood steps.

In specific endeavors involving robotics (or any sort of autonomous or semi-autonomous machinery), and irrespective of how an ordered series of steps is synthesized, there is always the looming question, “Is it safe to carry out this next step?” More particularly, since robots are operated by computers, the looming questions might be, “Given the choice of two obstacles in a path to a desired endpoint, which obstacle, if any, should I avoid,” and/or “Which obstacle can I safely move in order to proceed on a path to a desired endpoint?” and/or “Which obstacle can I safely collide with (or ignore) in order to proceed on a path to a desired endpoint?”

Typical non-LLM answers as well as naive LLM-provided answers to the first question often involve avoiding all obstacles. Typical non-LLM answers as well as naive LLM-provided answers to the second question often requires touching/moving some of the obstacles, but such naive LLM-provided answers do not give details for how to reach the desired endpoint or achieve some particular goal. As such, the robot is unable to achieve the stated objective. This is (at least) because the LLMs do not fully grasp the concept of safety and how the concept of safety changes relative to a dynamically-changing real-world environment.

One way to address the deficiency of LLMs in this regard is to not use the LLMs at all, however this fails to take advantage of the LLMs for their ability to bridge the chasm between high-level (e.g., human-issued) commands and the needed lower level (e.g., code or robot language) maneuvering steps.

Another way to address the deficiency of LLMs is to train LLMs on various safety-sensitized corpora, however this is often a non-starter due to the cost of such training and the vagaries of determining what constitutes (and how to access) the aforementioned safety-sensitized corpora.

What is needed is a way to address the foregoing deficiencies of LLMs as it pertains to safe operation of autonomous machinery. The problem to be solved is, therefore, rooted in various technological limitations of legacy approaches. Improved technologies are needed. In particular, improved applications of technologies are needed to address the aforementioned technological limitations of legacy approaches.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and computer program products for ensuring safe execution of AI-generated robotic commands and/or for ensuring the safe execution of robotic commands using safety semantics provided by an LLM. The various respective and herein-disclosed techniques advance the relevant technologies to address technological issues with legacy approaches. More specifically, the present disclosure describes techniques used in systems, methods, and in computer program products for transforming natural language (or computer markup language) output of LLMs to comport with safety constraints. Certain embodiments are directed to technological solutions for translating a language-based description (e.g., of an environment and/or of constituents therein) into robotic signals that comport with applicable safety constraints.

The disclosed embodiments modify and improve beyond legacy approaches. In particular, the herein-disclosed techniques provide technical solutions that address the technical problems that arise due to the deficiency of autonomous systems to ensure safe behavior while pursuing step-oriented tasks. Such technical solutions involve specific implementations (e.g., data organization, data communication paths, module-to-module interrelationships, etc.) that relate to the software arts for improving computer functionality.

The ordered combination of steps of the embodiments serve in the context of practical applications that perform steps for translating natural language into robotic signals that comport with dynamically feasible safety constraints. Such, techniques for translating natural language into robotic signals that comport with applicable safety constraints overcome heretofore unsolved technological problems associated with the inability of autonomous vehicles to ensure safe behavior while pursuing step-oriented tasks.

Many of the herein-disclosed embodiments for translating natural language into robotic signals that comport with applicable safety constraints are technological solutions pertaining to technological problems that arise in the hardware and software arts that underlie robot deployments. Aspects of the present disclosure achieve performance and other improvements in peripheral technical fields including, but not limited to, commanding robots using natural language and purpose-driven labeling of large language model output.

Some embodiments include a sequence of instructions that are stored on a non-transitory computer readable medium. Such a sequence of instructions, when stored in memory and executed by one or more processors, causes the one or more processors to perform a set of acts for translating natural language into robotic signals that comport with applicable safety constraints.

Some embodiments include the aforementioned sequence of instructions that are stored in a memory, which memory is interfaced to one or more processors such that the one or more processors can execute the sequence of instructions to cause the one or more processors to implement acts for translating natural language into robotic signals that comport with applicable safety constraints.

In various embodiments, any combinations of any of the above can be organized to perform any variation of acts for transforming natural language output of LLMs to comport with safety constraints, and many such combinations of aspects of the above elements are contemplated.

Further details of aspects, objectives and advantages of the technological embodiments are described herein and in the figures and claims.

### BRIEF DESCRIPTION OF THE DRAWINGS

The drawings described below are for illustration purposes only. The drawings are not intended to limit the scope of the present disclosure.

FIG. 1A compares a naive processing flow with an improved processing flow that is used in systems that transform natural language robot commands into commands that comport with safety constraints, according to an embodiment.

FIG. 1B shows a robotic system stack that interfaces an autonomy software stack directly with a robotic control stack.

FIG. 1C shows a supervisory layer that is situated between an autonomy software stack and a robotic control stack, according to an embodiment.

FIG. 1D shows an example supervisory layer instance having supervisory layer components that are configured to transform natural language output of LLMs into robotic control signals that comport with safety constraints, according to an embodiment.

FIG. 1E shows an example label information representation and meaning regime as used for labeling natural language output of LLMs, according to an embodiment.

FIG. 2A depicts a sample planning signal modification flow that is configured to transform labeled planning signals into modified planning signals that comport with safety constraints, according to an embodiment.

FIG. 2B depicts an example collision tolerance spectrum as used in collision tolerance-aware systems, according to an embodiment.

FIG. 3A depicts an example environment-aware prompt engineering flow as used in systems that transform natural language output of LLMs into robotic control signals that comport with safety constraints, according to an embodiment.

FIG. 3B depicts a safe behavior guarantee technique as used in systems that transform natural language output of LLMs into robotic control signals that comport with known-safe robotic behavior, according to an embodiment.

FIG. 4A depicts an example collision tolerance processing flow as used in systems that transform natural language output of LLMs into robotic control signals that comport with known-safe robotic behavior, according to an embodiment.

FIG. 4B depicts an example autonomous vehicle control system use case that illustrates the utility of autonomously permitting certain collision courses, according to an embodiment.

FIG. 5A contrasts a naïve, labor-intensive approach with a computer-implemented approach, according to an embodiment.

FIG. 5B depicts an example implementation of a robotic safety constraint derivation technique as used in systems that transform step-oriented LLM outputs into safety constraints, according to an embodiment.

FIG. 5C depicts an example implementation of an environment-aware prompt engineering technique as used in systems that transform natural language output of LLMs into robotic control signals that comport with safety constraints, according to an embodiment.

FIG. 6 depicts system components as arrangements of computing modules that are interconnected so as to implement certain of the herein-disclosed embodiments.

FIG. 7 depicts a physical setting in which embodiments of the present disclosure can be practiced.

FIG. 8A depicts a block diagram of an instance of a computer system suitable for implementing embodiments of the present disclosure.

FIG. 8B depicts an environment in which a behavior guarantee module can be implemented.

FIG. 8C1 depicts a block diagram of an interstitially situated supervisory agent, in accordance with some implementations.

FIG. 8C2 depicts a block diagram involving a human operator's safe manipulation of a robotic control system, in accordance with some implementations.

FIG. 8D depicts a safe signal generation technique, in accordance with some implementations.

### DETAILED DESCRIPTION

Aspects of the present disclosure solve problems associated with using computerized robot systems to ensure safe behavior while pursuing accomplishment of a robotic mission. Some embodiments are directed to approaches for translating natural language and/or high-level markup language into robotic signals that comport with applicable safety constraints. The accompanying figures and discussions herein present example environments, systems, methods, and computer program products for transforming natural language output of LLMs into robotic control signals that comport with safety constraints.

### OVERVIEW

The present invention pertains to a safety supervisory agent designed to facilitate safe and efficient robot operations by interpreting high-level environment descriptions expressed in a natural language or markup language format, and then ensuring that only safe robotic commands are carried out. Traditional methods of robot control often require programming skills and extensive human intervention to ensure safety while pursuing specific tasks. This novel safety supervisory agent aims to bridge the gap between high-level intent and low-level execution, enabling robots to operate autonomously and safely, even in dynamic environments, and even in the absence of the aforementioned programming skills or ongoing human intervention.

The safety supervisory agent employs advanced natural language processing (NLP) techniques, leveraging cutting-edge machine learning algorithms to comprehend and extract the underlying meaning of human-provided high-level objectives. By parsing the input text, the system effectively translates ambiguous human language into clear and concise low-level safety specifications, encompassing actions, behaviors and constraints that the robot must adhere to throughout its operation. Various embodiments include the steps of (1) obtaining a high level objective, (2) processing the high level objective through a prompt builder, (3) providing the engineered prompt to an artificial intelligence entity, (4) interpreting the response of the artificial intelligence entity to the prompt, and (5) passing portions of the interpreted response to a supervisory agent.

To ensure the robot operates within safe boundaries while pursuing the desired objective, the supervisory agent incorporates state-of-the-art safety algorithms. These algorithms continuously analyze the robot's actions and environment, identifying potential risks and hazards. If any prescribed robotic action would violate any one or more safety constraints or otherwise pose a danger, the safety supervisory agent promptly intervenes, adjusting the robot's trajectory or halting its operation altogether to prevent accidents or damage to assets or damage to the robot itself.

### Features of a Safety Supervisory Agent

The safety supervisory agent presented in this disclosure revolutionizes the way robots interact with their environments by using an artificial intelligence agent to translate knowledge of an environment and high-level constraints (e.g., expressed in natural language) into safety-conscious low-level action or avoidance specifications (e.g. robotic signals) that are carried out autonomously by a robot. Enabling robots to operate with a higher level of autonomy while nevertheless ensuring safety advances the technology facilitates widespread adoption of robots in various industries.

Selected features of this approach are given in Table 1.

TABLE 1
Selected features

| Technological | |
|---|---|
| Area | Description |
| Enhanced | By translating high-level descriptions or video feeds into |
| Safety | safe low-level commands, the robot is able to |
| | autonomously identify unsafe actions and avoid them, |
| | thus minimizing the likelihood of accidents and ensuring |
| | the well-being of humans, other living things, and |
| | environmental surroundings. |
| Autonomy | With a natural language interface, robots can be easily |
| and | instructed by non-technical personnel, reducing the need |
| Flexibility | for specialized programming, thus streamlining the |
| | deployment of robots. |
| Adaptability | The system can continuously learn from new safety data, |
| | improving its safety specifications and adapting to novel |
| | scenarios, making the robot more adept at handling |
| | diverse tasks over time. |
| Scalability | The safety supervisory agent is designed to accommodate |
| | various types of robots and objectives, making it |
| | applicable to a wide range of robotic applications and |
| | industries. |

### Example of Using an Artificial Intelligence Agent to Achieve a Robotic Mission

Imagine a room where there is a miniaturized terrestrial vehicle (e.g., similar to a toy remote control car) sitting stationary on the ground. In this imaginary room, situate a camera in the corner of the imaginary room. Now, consider what happens when the “mission” is to get the miniaturized terrestrial vehicle to the other side of the room, in spite of the fact that there are two objects (both being detected by the camera imaging and post processing) in the room blocking a direct path. Using classical computer vision techniques, one object is identified as a vase, and the other one is a blanket.

Now, suppose we prompt a generative AI large language model (e.g. ChatGPT), “Given an environment of a room where there are two objects (specifically a vase and a blanket) blocking a direct path from where the miniaturized terrestrial vehicle is now to the other side of the room, how can the miniaturized terrestrial vehicle be controlled to get from where it is now to the other side of the room?” In this example, and given the foregoing prompt, the AI large language learning model responds, “To get the miniaturized terrestrial vehicle from where it is now to the other side of the room while avoiding the vase and the blanket, you can perform the sequence of steps as given in Table 2.” Additionally or alternatively, consider if the AI large language learning model was a multi-modal large language learning model, in which case the image of the room was provided to the large language learning model. In this case, the large language learning model would classify the objects, as well as provide safety analysis. Consider the sequence of steps given in Table 2.

TABLE 2
Example LLM-provided step-wise response

| Step | |
|---|---|
| Index | Step Description |
| 1 | Approach the vase and check if it is heavy or fragile. If it's |
| | lightweight and not fragile, you can nudge it to the side to create |
| | a clear path. |
| 2 | If the vase is too heavy or too delicate to nudge, you can |
| | nmaneuver around the vase, making sure ot bump into it. |
| 3 | Navigate slowly over the blanket, avoiding any sudden braking, |
| | turning or other acceleration. |
| 4 | Continue over the blanket until you safely reach the other side of |
| | the room. Then stop. |

### Prompt Engineering

When carrying out a conversation with a generative AI entity (e.g. one that employs one or more large language models), the AI entity can incorporate context that was garnered from previous prompts. As such, suppose that the AI entity is given the prompt, “Can you write me code that allows the miniaturized terrestrial vehicle to safely reach the other side of the room, yet still avoids damaging any potential obstacles?” The AI entity might be able to generate low-level commands that, as a whole, carry out the foregoing steps 1, 2, 3, and 4 of Table 2. The AI entity's might be pre-trained to provide highly detailed commands. Or, the AI entity might be pre-trained to output code (if requested). In some cases, an AI entity can be ‘forced’ to respond in a particular format (e.g., by providing a description of the particular format in a prompt). As such, when an AI large language model is prompted with a command, the LLM provides a high-level step-by-step response that comports with a particular format. For example, if during the conversation with the AI entity, such as when describing any aspects of the particular then-current environment to the LLM, the LLM can be commanded via a purposely contrived prompt to return results in a tabular format. Then in response to the purposely contrived prompt, “The mission is to get the miniaturized terrestrial vehicle to the other side of the room, and I need a tabularized step-by-step response, as well as an assessment and prioritization of the safety considerations of objects in the room” the AI entity might respond with all or portions of the steps/descriptions given in Table 3.

TABLE 3
Detailed step-by-step response

| Step | |
|---|---|
| Index | Step Description |
| | As an AI large language model, I can provide you with an |
| | example high-level algorithmic description of how you could |
| | outline such code. There are many possibilities. Here is one |
| | possibility that is organized into an ordered series of steps: |
| 1 | Initialize the robot and its sensors. |
| 2 | Start moving the robot in the desired direction (toward the other |
| | side of the room). |
| 3 | Continuously read sensor data to detect any obstacles in the |
| | robot's path. |
| 4 | If an obstacle is detected: |
| | a. Determine the type of obstacle (e.g., vase or blanket). |
| | b. Decide the appropriate action based on the obstacle type |
| | (e.g., move around it, avoid it, or pick it up and/or move it). |
| | c. Take necessary actions to avoid the obstacle (e.g., steer the |
| | robot away from it or stop and wait until the obstacle is moved). |
| 5 | If there are no obstacles or after successfully avoiding an |
| | obstacle, continue moving towards the other side of the room. |
| 6 | Repeat steps 3 to 5 until the robot safely reaches the other side |
| | of the room. |

As can be seen, this second AI entity response as shown in Table 3 is at a lower level than the first AI entity response as shown in Table 2. Various approaches to achievement of a robotic mission can be expressed in varying degrees of abstraction, and the degree of abstraction can be controlled by prompt engineering. Moreover, the degree of abstraction in the “how to” steps given by an AI entity can be fine-tuned to facilitate transformation of the AI entity's “how to” steps into safe robotic control signals. For example, a “how to” step that carries the semantics of, “pick up the object” might be transformed into a safe robotic control signal that carries the semantics of, “pick up the object using no more than 1 Newton of force,” or “pick up the object only by the object's handle.”

Various techniques to transform an AI entity's “how to” steps into safe robotic control signals are shown and described with reference to various example embodiments.

### Definitions and Use of Figures

Some of the terms used in this description are defined below for easy reference. The presented terms and their respective definitions are not rigidly restricted to these definitions-a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiment even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

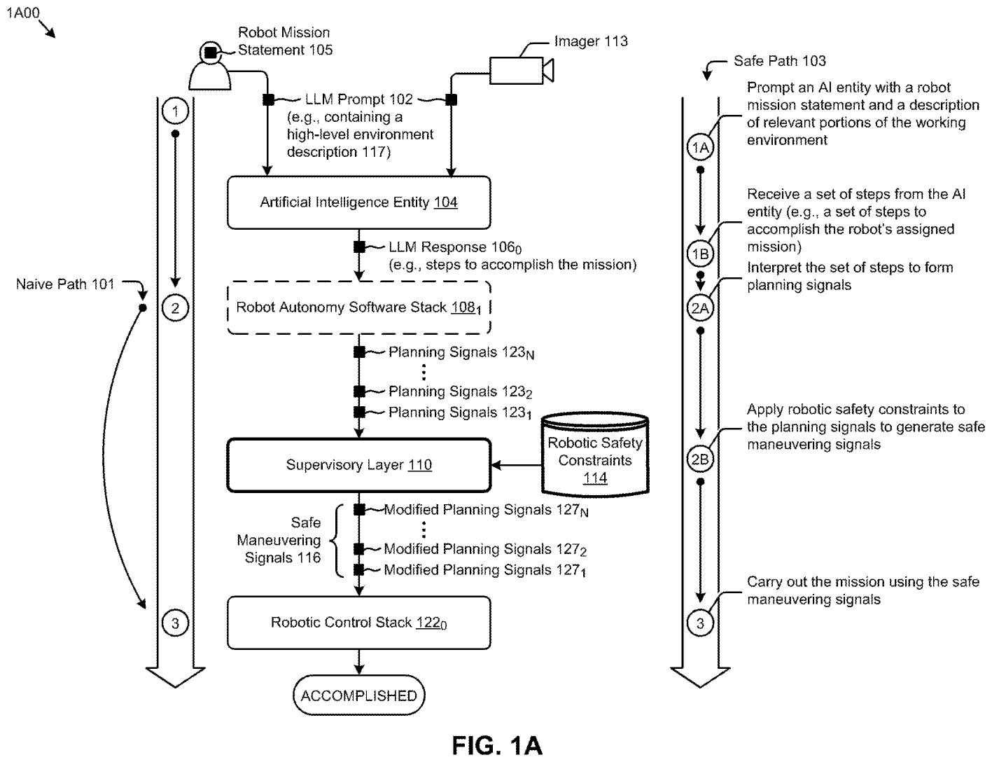

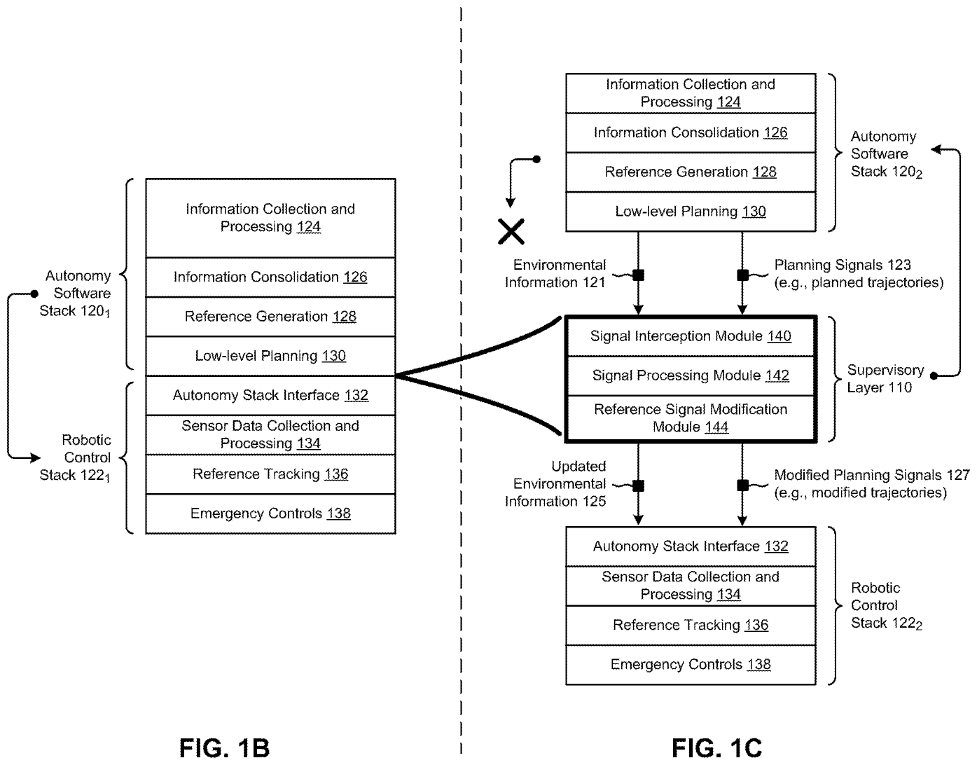

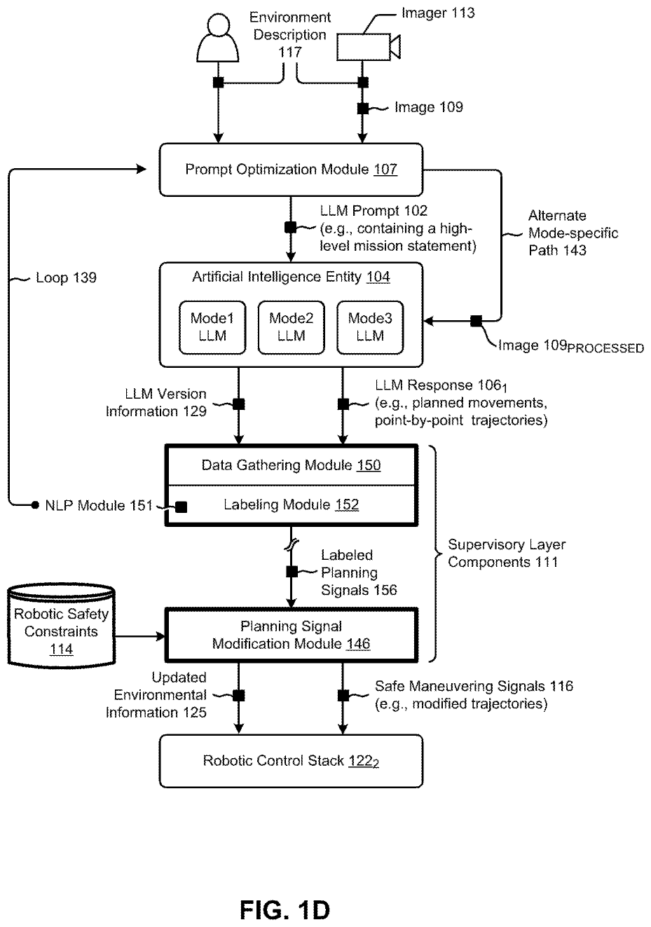

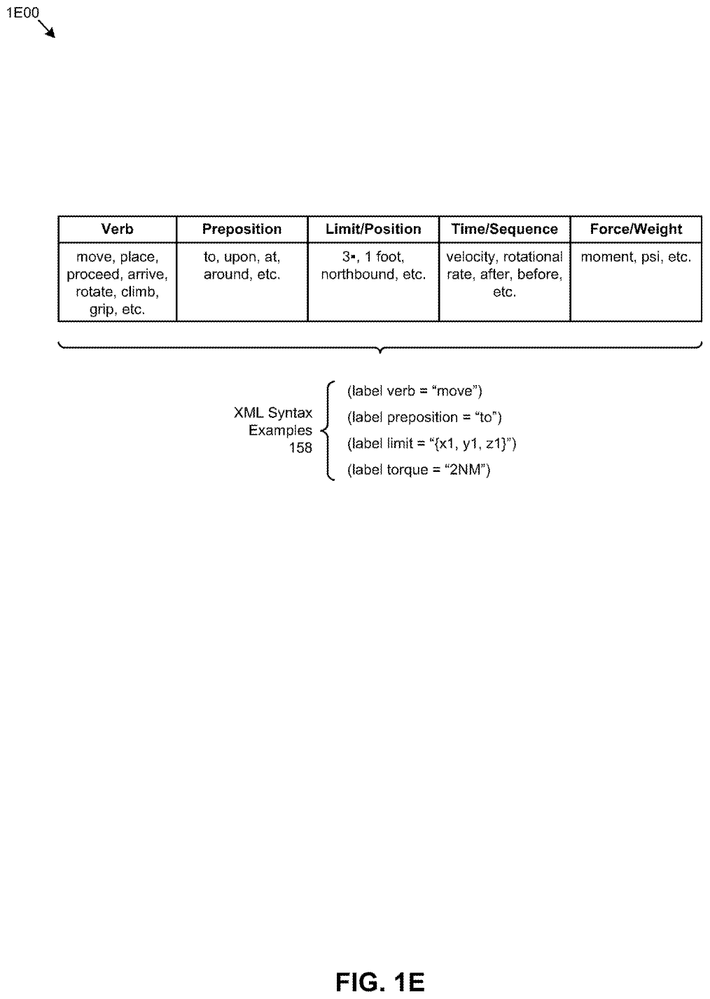

FIG. 1A compares a naive processing flow with an improved processing flow that is used in systems that transform natural language robot commands into commands that comport with safety constraints. As an option, one or more variations of an improved processing flow 1A00 or any aspect thereof may be implemented in the context of the architecture and functionality of the embodiments described herein and/or in any environment.

The figure is being presented to illustrate how an improved processing flow might be configured to operate in systems that transform natural language robot commands into low-level commands or signals. More specifically, the figure is being presented to illustrate how the herein-disclosed techniques advance over legacy techniques.

Specifically, the left side of the figure presents a multi-step processing flow including the shown naive path 101. At the shown step 1 (left side of the figure), a robot mission statement 105 is provided to artificial intelligence entity 104 as a large language model (LLM) prompt in order to receive robot instructions (e.g., LLM response 106₀). At step 2, the robot autonomy stack's (e.g., robot autonomy software stack 108₁) outputs are consumed by robotic control stack 122₀ at processing step 3. As shown, this naive path fails to traverse through the shown supervisory layer 110, which in turn means that in this naive path, any of the planning signal outputs from the robot autonomy stack (e.g., planning signals 123₁, planning signals 123₂, . . . , planning signals 123_{N}) are directly consumed by a robotic control stack 122₀ without being at processed with respect to the shown supervisory layer 110 and robotic safety constraints 114. This is highly undesirable, at least in that this naive flow leaves open the possibility that signals provided to the robot might result in unsafe robot behavior. This is highly unwanted since human life as well as assets might be jeopardized by said unsafe robot behavior.

In accordance with this naive path 101, there is no guarantee that the steps to accomplish the mission (e.g., outputs from the artificial intelligence entity) are safe. In fact, since outputs from an LLM are merely the most likely words that follow a prompt and its context, there is every possibility that the most likely words that follow this type of prompt and its context are inherently dangerous or at least unwitting with regards to safety.

What is needed is a way to turn outputs from an LLM into low level robotic commands that are guaranteed to be safe. One way to do so is shown as safe path 103. In safe path 103, rather than merely providing the artificial intelligence entity with a naked robot mission statement, step 1A serves to provide the LLM with a high-level environment description 117, possibly in the form of imagery from an imager 113, such that when the LLM response from artificial intelligence entity 104 is received into operational elements of the safe path, the received LLM response is based on informed characteristics of the environment. This is shown in the specific embodiment of FIG. 1A as step 1B.

An autonomy stack (e.g., robot autonomy software stack 108₁) might or might not be consulted in the safe path (as indicated by the dotted line boundary). Regardless of the specific implementation or configuration of any autonomy stack, at step 2B, the set of steps output by the LLM (e.g., a set of steps to accomplish the mission) are interpreted at step 2A and reformatted as needed into planning signals. At step 2B, the planning signals undergo processing by the supervisory layer which in turn applies robotic signal constraints to modify the planning signals, resulting in safe maneuvering signals (e.g., modified planning signals 127₁, modified planning signals 127₂, . . . , modified planning signals 127_{N}). These safe maneuvering signals 116 are, in turn, used to drive robotic control stack 122₀ which, at step 3 (safely) performs the set of steps to accomplish the mission by executing robot controls in accordance with said safe maneuvering signals.

The foregoing written description pertains to merely one possible embodiment and/or way to implement an improved processing flow. Many variations are possible, for example, the aforementioned supervisory layer and/or any variation of its inputs and outputs can be implemented in any environment or in accordance with any architecture, one example of which pertains to a robotic system stack as shown and described in the following figures.

FIG. 1B shows a robotic system stack that interfaces an autonomy software stack directly with a robotic control stack. As an option, one or more variations of robotic system stack or any aspect thereof may be implemented in the context of the architecture and functionality of the embodiments described herein and/or in any environment.

Those of ordinary skill in the art will recognize the architecture of a robotic system stack, whereby a mission or command stack (e.g., the shown autonomy software stack 120₁) interfaces with an actuator subsystem (e.g., the shown robotic control stack 122₁).

In this two stack architecture, planning signals flow from the mission or command stack to the actuator subsystem. What is needed is a way to intercept planning signals before they reach the actuator subsystem. A technique for such interception is shown and described as pertains to FIG. 1C. A description of the architecture and inner workings of the autonomy software stack and its interface to the robotic control stack follows.

As shown, autonomy software stack 120₁ is composed of several layers, which layers interoperate so as to carry out specific types of processing. Strictly to illustrate, consider the layer assignments given in Table 4.

TABLE 4
Step breakdown

| Layer/ | |
|---|---|
| Function | |
| Name | Description |
| Information | This layer (e.g., information collection and processing |
| collection and | 124) collects data from higher-level sensors (such as |
| processing | cameras and LIDARs), as well as high-level actions |
| 124 | (such as “go to position [X,Y,Z]”). |
| Information | This layer updates the system's understanding of itself |
| consolidation | and its environment based on a totality of information. |
| 126 | In some cases, this layer interprets the totality of |
| | information to resolve to some high-level actions. |
| | More specifically, this layer gathers specific |
| | parameters that are in turn used for decision making. |
| Reference | Reference trajectories are generated based on the |
| generation | system's understanding of the world, a given mission |
| 128 | or objectives on the way to achievement of the given |
| | mission, and any constraints given by the operator. |
| | Sometimes this activity is referred to as high-level |
| | planning. This activity is typically calculated/ |
| | recalculated at a rate of ~1-10 Hz. |
| Low-level | A low-level planner takes higher-level reference |
| planning 130 | information, such as a sequence of desired waypoints, |
| | and outputs lower-level reference signals, such as |
| | velocity-controlling signals and/or other signals that |
| | can in turn be used to track progression through the |
| | sequence of waypoints. This activity is typically |
| | calculated/recalculated at a rate of ~10-100 Hz. |

As shown, robotic control stack 122₁, is composed of several depicted as layers. These layers are interfaced with each other so as to perform under a wide variety of stack architectures. Strictly as examples consider the stack architectures as discussed in Table 5.

TABLE 5
Layered stack architecture breakdown

| Layer | Layer Description |
|---|---|
| Stack | This is where the robotic system sends and receives |
| Architecture | information from the autonomy stack. It receives necessary |
| Layer 1: | information needed for the robot to move, such as the |
| Autonomy | reference signal and some real-world information. It sends |
| stack | information to the autonomy stack, such as the raw sensor |
| interface | data, or such as the robot's estimate of its states. In some |
| 132 | cases, this layer includes low level planning. That is, in |
| | some cases, rather doing low level planning in the |
| | autonomy stack layer, it is done at the robotic control stack |
| | layer. |
| Stack | Here, the robot takes in the real-time sensor data and |
| Architecture | processes it in a way that gives the robot the ability to |
| Layer 2: | track the reference signal. In some systems, state |
| Sensor data | estimation is done in, or by, or under control of, the |
| collection | autonomy stack layer. In such cases, sensor data collection |
| and | and processing 134 can be used for the purpose of |
| processing | producing feedback signaling responsive to actions |
| 134 | pertaining to tracking the control signal (e.g., when an |
| | estimate has been provided by the autonomy stack layer), |
| | and/or the sensor data collection and processing can be |
| | used for direct in situ measurements of the state of the |
| | robot (e.g., when an estimate has not been provided by |
| | the autonomy stack layer). More specifically, the |
| | foregoing sensor data collection and processing involves |
| | movement tracking by comparing then-current |
| | environmental measurement data and then-current |
| | trajectory data with respect to an estimate. |
| Stack | This layer implements motor and solenoid actuation. The |
| Architecture | robot, specifically--referring to the processing within this |
| Layer 3: | layer--uses information from the foregoing layers' attempts |
| Reference | to track to the reference signal by actuating motors and |
| tracking | solenoids. This tracking is calculated/recalculated often, |
| 136 | such as at frequencies >1000 Hz. As used herein, the |
| | action “to track” or the term “tracking” and/or the phrase |
| | “tracking [a/the] control signal” refers to comparing actual |
| | in situ measurements with respect to an estimate. The rate |
| | at which such tracking is accomplished can be varied |
| | dynamically based at least in part on a set of measured |
| | then-current conditions. Moreover, the rate at which such |
| | tracking is accomplished can be initially determined (e.g., |
| | statically or dynamically) and then varied to accommodate |
| | precision tracking even in the case of rapidly changing |
| | conditions. For example, an initially determined sample |
| | rate might be increased to a higher rate when the robot |
| | is undergoing a particular maneuver, whereas any then- |
| | current sample rate might be decreased to a lower rate |
| | when the robot is dormant or stationary. |
| Stack | This is where safety systems like emergency stops and |
| Architecture | human takeovers can be implemented to shut off or |
| Layer 4: | otherwise override the system's plan. |
| Emergency | |
| controls 138 | |

Unfortunately, even in implementations that do include an emergency control layer, such implementations are often insufficient for safe operation, since merely dealing with emergency stops and human takeovers fails to consider the full range of safe operation of the robot. Moreover, use of such emergency controls often negatively impacts ongoing operations of the robot. For example, use of such emergency controls often introduces unwanted downtime-sometimes requiring a full system reset.

As can now be seen, the architecture of legacy implementations such as depicted in FIG. 1B fails to implement any sort of arbitration of signaling between the autonomy software stack and the robotic control stack in a manner that provides for safe operation of the robot over all conceivable operational scenarios. What is needed is a supervisory layer, at least a portion of which is situated between the autonomy software stack and the robotic control stack.

FIG. 1C shows a supervisory layer that is situated between an autonomy software stack and a robotic control stack. As an option, one or more variations of supervisory layer or any aspect thereof may be implemented in the context of the architecture and functionality of the embodiments described herein and/or in any environment.

FIG. 1C is being presented on the same sheet as FIG. 1B to highlight how a supervisory layer can be situated interstitially between the autonomy software stack and the robotic control stack. Specifically, supervisory layer 110 is juxtaposed between autonomy software stack 120₂ and robotic control stack 122₂. As shown, the supervisory layer is composed of signal interception module 140, signal processing module 142, and a reference signal modification module 144. The supervisory layer (1) receives an ongoing stream of planning signals 123 (e.g., planned trajectories) and environmental information 121, (2) processes those signals in conjunction with the environmental information, (3) and modifies the planning signals to create an ongoing stream of modified planning signals 127 (e.g., with modified trajectories that are guaranteed to be safe). The modified planning signals are provided to the robotic control stack such that the robot can be operated in a safe manner.

The foregoing is merely one modularized implementation of a supervisory layer. More (or fewer) or different functions of the supervisory layer can be implemented using any known computer module partitioning techniques and/or using any known signal processing techniques. Further, although the foregoing discussion characterizes the planning layer as being composed of an autonomy software stack, any portion of the planning layer can include or be interfaced with hardware components and/or further software components.

An example of instancing a supervisory layer is shown and described as pertains to FIG. 1D.

FIG. 1D shows an example supervisory layer instance having supervisory layer components that are configured to transform natural language output of LLMs into robotic control signals that comport with safety constraints. As an option, one or more variations and/or partitioning of supervisory layer instance or any aspect thereof may be implemented in the context of the architecture and functionality of the embodiments described herein and/or in any environment.

The figure is being presented to illustrate how a prompt optimization module 107 might produce a prompt (e.g., LLM prompt 102, image 109), which in turn is provided (e.g., as image 109_{PROCESSED}) via alternate mode-specific path 143 as an input to artificial intelligence entity 104, which artificial intelligence entity 104 might include multiple modes (e.g., text mode mode1, audio mode mode2, image mode mode3, etc.), where the multiple modes are configured to receive a prompt that corresponds to the mode. For example, when operating in a text mode, the artificial intelligence entity receives prompts in the form of a textualized natural language description, whereas, when operating in an audio mode, the artificial intelligence entity receives prompts in the form of an audible natural language description (e.g., speech), whereas, when operating in an image mode, the artificial intelligence entity receives prompts in the form of an image or as a series of images.

Further, FIG. 1D shows how a supervisory layer might be configured to operate on outputs from the aforementioned artificial intelligence entity. Specifically, and as shown, various supervisory layer components 111 interface with artificial intelligence entity 104, whereas various other supervisory layer components interface with the robotic control stack 122₂.

A data gathering module 150 is interfaced with the artificial intelligence entity 104 so as to be able to receive LLM response 1061. Such a data gathering module, as well as any other supervisory layer components 111, can be configured to interpret an LLM response with respect to the particular artificial intelligence entity. This is shown in this embodiment by the appearance of LLM version information 129 as an output from the artificial intelligence entity 104, which is an input to the data gathering module. In some cases the LLM version information informs how labeling is performed in labeling module 152. More specifically, the LLM version information informs how natural language processing (NLP) is performed (e.g., via NLP module 151). Strictly as one example, the LLM version information might inform, via the NLP module, what language (e.g., English, French, German, Japanese, etc.) is being used by the artificial intelligence entity's LLM. In other cases, the LLM version information corresponds to the level or granularity of the corpora that were used to train this particular version of the LLM. In still other cases, the LLM version might carry information about the modality and/or capabilities of the LLM.

In some cases, one or more of the supervisory layer components feed back to prompt optimization module 107, which might begin the flow anew from the top. As is known in the art, the scope and style and format of the output of an LLM depends significantly on the prompt. As such, it often happens that loop 139 is traversed several times before the supervisory layer components output labeled planning signals 156. The specific labels that correspond to the foregoing labeled planning signals are present so as to inform planning signal modification module 146 with sufficient metadata (e.g., information about the signal and/or the signal's constituent components). Such metadata informs processing within the planning signal modification module on what robotic safety constraints 114 might be applicable to any particular planned movements.

Outputs from the planning signal modification module are deemed to be safe maneuvering signals 116 that are deemed to be safe if the robot performs the maneuvers within the then-current environment. To this end, planning signal modification module 146 outputs the then-current, updated environmental information 125, some of which then current environmental information might be provided to robotic control stack 122₂. The robotic control stack then applies the safe signals to motors and actuators of the robot. To explain (1) how a label affects modification of a planning signal for safety and (2) how the labels (aka metadata) are generated in the first place, consider the label information representation and meaning as shown in FIG. 1E.

FIG. 1E shows an example label information representation and meaning regime 1E00 as used for labeling natural language output of LLMs. In this example, the regime is represented as a matrix of information, however any information representation technique (e.g., markup language, computer code, etc.) can be used.

As shown, natural language constructs (e.g., parts of speech) and/or high-level language constructs can be distilled into canonical forms, either singly or in combination, which canonical forms can in turn be construed as planning signals. More particularly, such canonical forms can be processed (e.g., via a labeling module) into of a variety of representations that constitute labeled planning signals (see the labeled planning signals 156 of FIG. 1D). As shown, one of the aforementioned representations of labeled planning signals are exemplified using extensible markup language (XML) syntax (e.g., the element ‘(label verb=“move”)’, the element ‘(label torque=“2MN”), etc.). As can be understood, all or portions of these labeled planning signals (e.g., as exemplified by XML syntax examples 158) are in turn considered for modification so as to comport with safety considerations. In exemplary cases, these labeled planning signals inform values or ranges for control limits (e.g., “not more than 2 MPH”) or values or ranges for control requirements (e.g., “at least 1.85NM of torque and not more than 1.95NM of torque”).

Using these labeled planning signals, it is possible to generate a modified (safe) planning signal for maneuvering to a particular position. This is because the robot is subjected to a set of in-force robotic safety constraints that cover robot movements. In some cases, the set of in-force robotic safety constraints pertain to protection of assets in addition to the robot itself. In some cases, the set of in-force robotic safety constraints pertain to protection of the environment or aspects thereof.

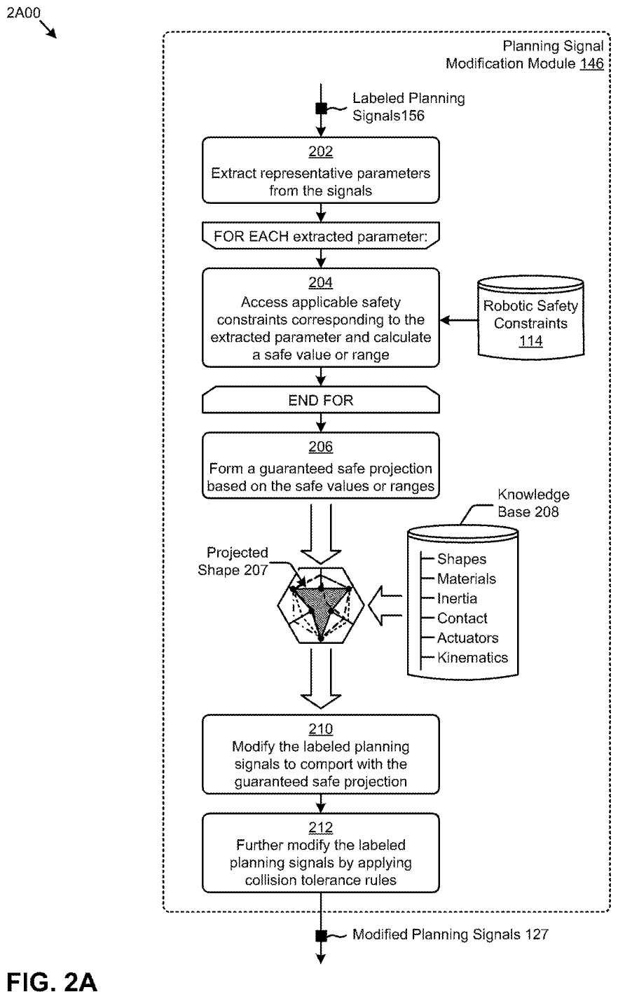

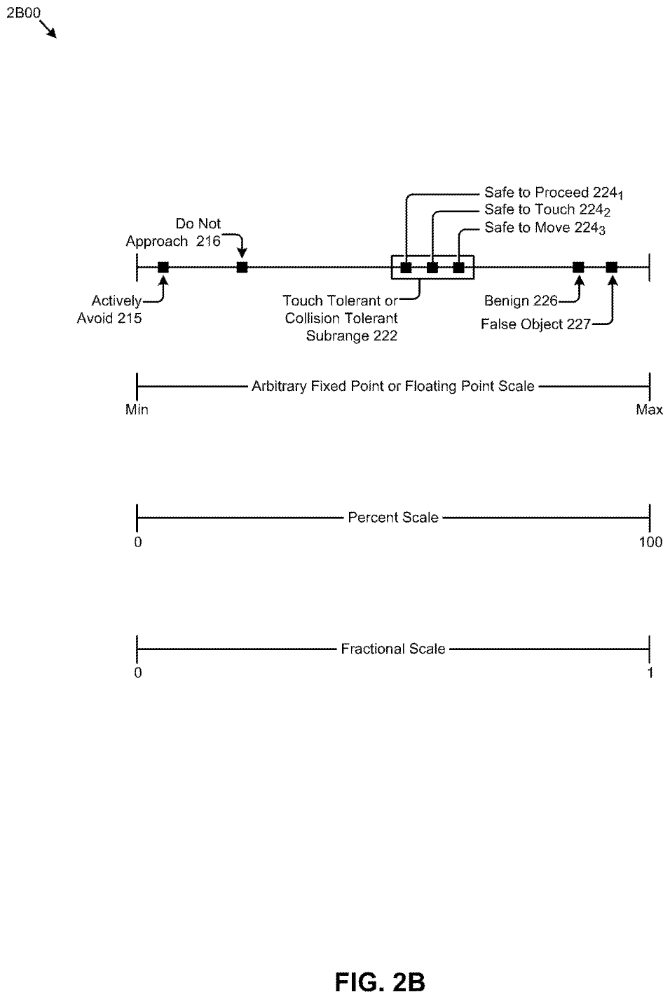

The foregoing written description pertains to merely some example embodiments and/or to merely some way to implement a supervisory agent. Many variations are possible, for example, the supervisory layer partitioning as comprehended in the foregoing can be implemented in any environment or control flow, one example of which is shown and described as pertains to FIG. 2A.

FIG. 2A depicts a sample planning signal modification flow that is configured to transform labeled planning signals into modified planning signals that comport with safety constraints. As an option, one or more variations of planning signal modification flow 2A00 or any aspect thereof may be implemented in the context of the architecture and functionality of the embodiments described herein and/or in any environment.

The figure is being presented to illustrate how a planning signal modification flow might be configured into a planning signal modification module 146 that is designed to provide safe signaling to a robot that is deployed into a particular environment.

Specifically, and as shown, planning signal modification module 146 breaks down a signal into contributory parameters. Then, for each extracted parameter (step 202), one or more robotic safety constraints are applied to the parameter (step 204). In some cases, this results in bounding the parameter value range only to a particular safe range of values. For example, a signal that carries the semantic, “Go forward 5 feet” might be implemented by the robot logic as “Turn forward thrusters on until your position increases by 5 feet,” which might be modified to specify a speed, as in “Set forward thrusters to not more than 50% of full power until your position increases by 5 feet.” Such signals are guaranteed to be dynamically feasible. That is, a robotic command that expresses the semantic of “don't hit the wall”, becomes dynamically feasible by bounding a parameter value range to a particular safe range of values. By applying the techniques discussed herein, a command such as “don't hit the wall” can be recoded into signals that carry the semantics of, “slow down to 4 m/s if ever you are 2 meters or less away from the wall” (e.g., because the robot can only safely brake within a given acceleration range).

The foregoing application of robotic safety constraints can be carried out to consider any/all of a plurality of extracted parameters. Moreover, while the foregoing discussion of making modifications to planning signals, it often happens that safely carrying out steps corresponding to the planning signals might need to be considered relative to the robot's then-current environment. That is, while it might be intrinsically safe to command a subject vehicle to, for example, “Set forward thrusters to not more than 50% of full power until your position increases by 5 feet,” it might be deemed to be unsafe when considering the robot's then-current environment. Accordingly, the further steps that implement planning signal modification module 146 serve to consider all of what can be known about a particular environment, whether the particular environment is static (e.g., substantially unchanging) or whether the particular environment is dynamic (e.g., frequently changing). In order to consider all of what can be known about a particular environment, knowledge base 208 is defined. The contents of knowledge base 208 might be static (e.g., substantially unchanging) or might be dynamic (e.g., frequently changing). In fact, the knowledge base might be informed wholly or partially by outputs of an LLM.

At step 206, the environment is considered and, more specifically, any/all characteristics or parameters, or values, etc. that are constituents of knowledge base 208 are considered with respect to safety. Safe values or ranges of any/all of the constituents of knowledge base 208 are organized into a computer representation of a safe projection. That is, safe values or ranges of any/all of the constituents of knowledge base 208 are combined (e.g., into a multivariate surface) such that no parameter is allowed to take on a value that is deemed to be unsafe. The definition of safe can sometimes be dynamic. More specifically, the definition of safe can sometimes be derived from dynamically-changing parameters and/or from dynamically-changing environmental variables, and/or the definition of safe can sometimes be derived from dynamically-changing constituents of knowledge base 208.

Strictly for illustration, FIG. 2A depicts the foregoing computer representation of a safe projection (e.g., projected shape 207) as a shape projected onto a plane (e.g., the surface of the page), however any number of parameters can be considered in a safe projection, and the projection need not be limited to any particular number of dimensions. For example, constraints on positions in cardinal directions, and/or constraints that control or limit linear and/or angular velocities could be projected into constraints pertaining to forces and moments applied to a system.

At step 210, all information that can be garnered from the knowledge base with respect to the labeled planning signals is applied to form modified planning signals, where a modified planning signal is modified in a manner that considers both the aforementioned robotic safety constraints as well as the safe projection.

In some situations, the foregoing constraints are so called “worst case” constraints, which might be overly conservative and in some cases can lead to safe, but non-optimal robotic behavior. Unfortunately, it can happen that multiple overly conservative constraints combine onto robotic behavior that is safe, but extremely non-optimal. In some cases, multiple overly conservative constraints combine onto robotic behavior that is infeasible to the extent that the robot is unable to proceed in accomplishment of its assigned objective(s). In order to completely avoid such non-optimal (or otherwise undesired) robotic behavior, and/or to reduce the frequency of occurrences or severity of such non-optimal robotic behavior, step 212 serves to apply collision tolerance rules. The semantics of collision tolerance rules is in a range of permissiveness to avoidance, where a ‘high’ value of permissiveness (e.g., a value of ‘1’) on one end of a spectrum might permit an actual collision (e.g., a vehicle collision with an insect), and where a ‘low’ value of permissiveness (e.g., a value of ‘0’) might lead to absolute avoidance.

The notion of a collision permissiveness spectrum or a collision tolerance spectrum and/or the notion of collision tolerance awareness can be codified using any technique, some examples of which are shown and described as pertains to FIG. 2B.

FIG. 2B depicts an example collision tolerance spectrum as used in collision tolerance-aware systems. As an option, one or more variations of collision tolerance spectrum 2B00 or any aspect thereof may be implemented in the context of the architecture and functionality of the embodiments described herein and/or in any environment.

The figure is being presented to illustrate how a collision tolerance spectrum might be codified to operate in a particular environment. Strictly as a non-limiting example, a collision tolerance spectrum might be mapped onto a unit scale, where each position on the unit scale corresponds to a fraction of the unit scale in the range [0,1). Any one of more of the fractional values can correspond to human-understandable semantics, such as to “avoid”, referring the points or ranges on the spectrum labeled as actively avoid 215, or do not approach 216 and referring to semantics that mean or imply an utter intolerance for any kind of collision or other contact (e.g., an immovable or dangerous object or boundary). Additionally or alternatively, any one of more of the fractional values can correspond to human-understandable semantics such as benign 226 or as false object 227, referring to a complete tolerance for collision or touching (e.g., a stratus cloud).

Of course the foregoing are merely examples, and many other human-understandable semantics are possible. Moreover, any one or more human-understandable semantics can be grouped based on some similarity of the tolerance and/or based on some a priori predictable subrange of tolerance (e.g., the shown touch tolerant or collision tolerant subrange 222). The subrange itself might be defined in whole or in part based on aspects of certain robotic actions and/or based on aspects of an a priori known safety constraint relaxation (e.g., safe to proceed 224₁, safe to touch 224₂, safe to move 224₃).

Again, the foregoing are merely examples and other semantics are possible. Moreover, some values along the collision tolerance spectrum might be dynamically calculated based on then-current conditions of the robot, and/or based on then-current conditions in the environment.

One of ordinary skill in the art will recognize that different configurations of collision tolerance spectra can be defined (e.g., a priori) based on knowledge of the environment. For example, while it might be deemed to be safe for a terrestrial vehicle to make contact with “Botts' dots” or even some small debris while negotiating a maneuver on a highway, it would be deemed to be highly unsafe for a space-borne vehicle to make any sort of contact with “space junk.”

Representation of collision tolerance spectra can be purely numeric (e.g., across a fractional scale, or in across a percent scale, or across an arbitrary fixed-point or floating-point scale). Additionally or alternatively, representation of collision tolerance spectra can be based on an ordered series of human understandable words or phrases that are in turn mapped to a representation that facilitates real-time calculations.

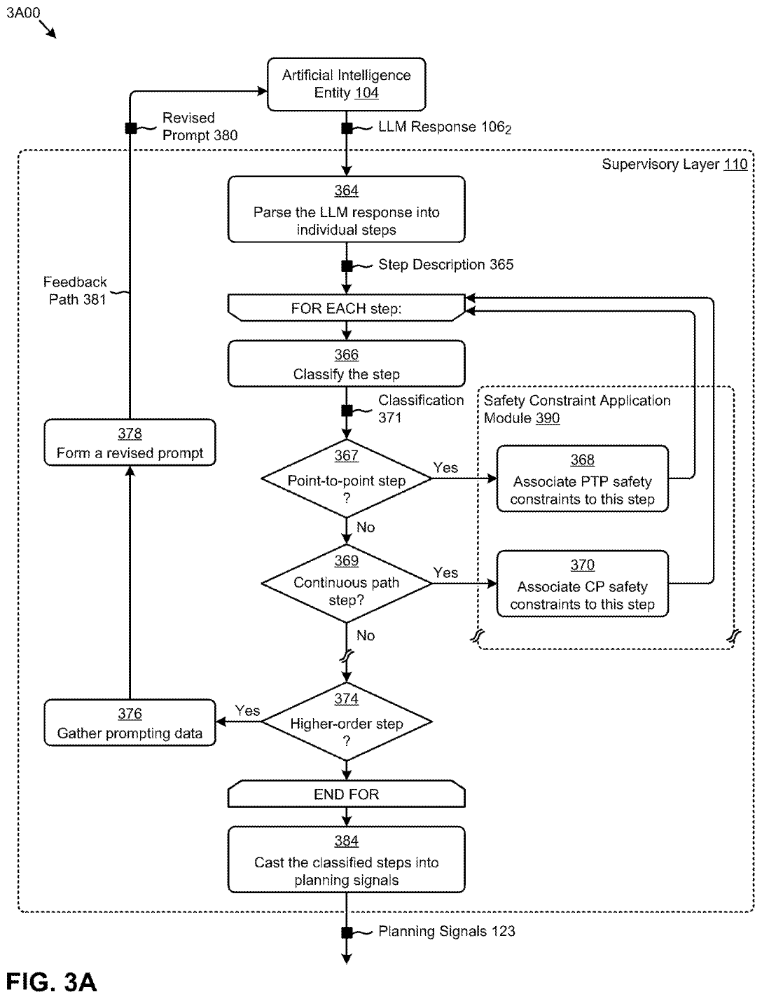

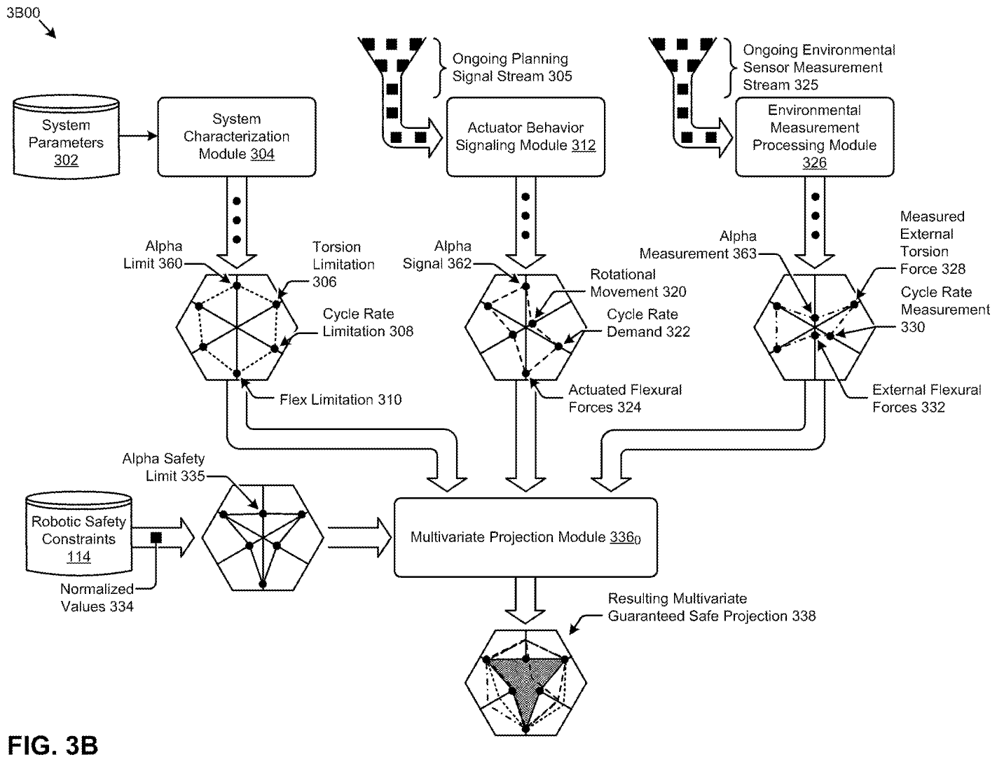

As can be seen, the notion of collision tolerance pertains to a fairly low level of granularity of robotic planning. For example the semantics of “safe to touch [a Botts' dot]” might well be applicable (e.g., actionable) when executing a “turn right at the corner” planning signal in a terrestrial vehicle, however it would not be immediately applicable if the robotic planning signal were of a higher level, such as “proceed from the Long Beach seaport to Third and Pico Avenue in Los Angeles.” Accordingly, it is felicitous to consider safety at lower levels of granularity. Fortunately, most AI entities, specifically LLMs, can be prompted to provide robot instructions at any desired level. Accordingly, systems that ensure safe execution of AI-generated robotic commands need to be aware of not only the granularity of the contents of an LLM response, but also be able to stimulate the LLM in a manner such that the LLM provides robot instructions at a particular desired level. Doing so is known in the art as “prompt engineering.” One way to do prompt engineering is shown and described as pertains to FIG. 3A.

FIG. 3A depicts an example environment-aware prompt engineering flow as used in systems that transform natural language output of LLMs into robotic control signals that comport with safety constraints. As an option, one or more variations of prompt engineering flow 3A00 or any aspect thereof may be implemented in the context of the architecture and functionality of the embodiments described herein and/or in any environment.

The figure is being presented to illustrate how an environment-aware prompt engineering flow might be configured to operate in, or in conjunction with supervisory layer 110. As shown, prompt engineering flow 3A00 includes feedback path 381, whereby artificial intelligence entity 104 can be prompted and re-prompted any number of times until the LLM returns robot instructions at a particular desired level of granularity. In this particular embodiment, LLM response 1062 is parsed into descriptions of individual steps (at step 364), where each individual step is then classified (at step 366) to produce a classification 371 that refers to a level of granularity.

Strictly as an example of such classification, a particular step description 365 can be classified as a point-to-point (PTP) step (via test 367) or the particular step description 365 can be classified as a continuous path (CP) step (via test 369), or the particular step description 365 can be classified as some other type of low-level step (not shown), or the particular step description 365 can be classified as being a higher-order step (at test 374). In that case, the “Yes” branch of test 374 is taken and the higher-order step then becomes the subject of prompt engineering involving gathering additional data (e.g., at step 376) and forming a revised prompt (e.g., at step 378).

Strictly as examples of the foregoing classification possibilities, if a particular step description 365 were to be classified as a point-to-point (PTP) step, then the “Yes” branch of test 367 would be taken and processing to associate PTP safety constraints with this classified step would be undertaken (at step 368). Additionally or alternatively, if a particular step description 365 were to be classified as a continuous path (CP) step, then the “Yes” branch of test 369 would be taken and processing to associate CP safety constraints with this classified step would be undertaken (at step 370). A particular step description 365 (e.g., a PTP step or a CP step) may contain a dimension, and/or a limit. In some embodiments, steps or other information in the LLM response may contain a safety rating pertaining to one or more aspects of the environment. Various representations and meanings of a dimension, as well as various representations and meanings of a limit, as well as various representations and meanings of a safety rating are discussed infra.

### Prompt Engineering

In this embodiment, prompt engineering involves gathering prompting data (e.g., at step 376), forming a revised prompt (e.g., at step 378) based on the gathered prompting data, and submitting the revised prompt 380 to the artificial intelligence entity.

At some point in this flow (e.g., after the END FOR), and possibly after multiple passes through the feedback path, all of the steps have been classified as being defined at a sufficiently low level that safety constraints and/or collision tolerance constraints that have been, or can be applied. Accordingly, the safe and possibly collision tolerant steps can be cast (at step 384) into planning signals 123.

There can be many classifications of any portions of the robot instructions given in an LLM response. Shown here for illustrative purposes are two examples of low level steps, namely PTP steps and CP steps. More particularly, when it is determined that a particular step description is a PTP step or that a particular step description is a CP step, the step description can be subjected to further safety processing as provided by the shown safety constraint application module 390.

Such a safety constraint application module may apply any number of constraints to a low level step. In this particular flow (e.g., through step 368 or through step 370) all or a portion of a point-to-point step (e.g., move from point ‘A’ to point ‘B’), or all or a portion of a continuous path step (e.g., move along a straight segment between point ‘A’ and point ‘B’), might be constrained to comport with movements (e.g., articulator movements) that are human-like. For example, when commanding a robotic arm to move its gripping utensil toward some object of interest, the various articulators such as elbow joints and/or wrist joints and so on can be constrained to move in a manner that models (e.g., via constraints) how human elbow joints and/or wrist joints move.

When operating a robot in a particular environment, both the characteristics of the robot (e.g., the robot control system) as well as the environment, may be replete with constraints. For example, a robot arm might only be able to move within a certain range of velocities, or for example, the environment might include boundaries or obstacles. Such constraints that at least potentially apply to characteristics of the robot itself as well as constraints that at least potentially apply to the environment are to be considered in systems that guarantee safe robotic behavior when executing AI-generated robotic commands. One possible technique to guarantee safe robotic behavior when executing AI-generated robotic commands is shown and described as pertains to FIG. 3B.

FIG. 3B depicts a safe behavior guarantee technique as used in systems that transform natural language output of LLMs into robotic control signals that comport with known-safe robotic behavior. As an option, one or more variations of safe behavior guarantee technique 3B00 or any aspect thereof may be implemented in the context of the architecture and functionality of the embodiments described herein and/or in any environment.

This safe behavior guarantee technique implements a multivariate projection module based on real-time parameter and signal streams. In this illustrative embodiment, parameter and signal values are plotted on a multi-variate spider chart. More particularly, three different sets of parameter and signal values are drawn from three different corpora; specifically, a first set of parameter values are drawn from system characterization values (e.g., derived from the shown system parameters 302), a second set of parameter values are drawn from real-time actuator signaling (e.g., derived from an ongoing planning signal stream 305), and a third set of parameter values are drawn from environmental conditions (e.g., derived from an ongoing environmental sensor measurement stream 325).

As shown, various modules are configured to ingest parameter values from the aforementioned corpora so as to process (e.g., normalize) any ingested set of parameter values for comparison to any other set or sets of parameter values. In the embodiment of FIG. 3B, system parameters 302 are ingested and processed by a system characterization module 304, an ongoing planning signal stream 305 is ingested and processed by an actuator behavior signaling module 312, and an ongoing environmental sensor measurement stream 325 is ingested and processed by an environmental measurement processing module 326.

### Normalization

The three different types of parameters are normalized with respect to a given dynamic range. For example, a parameter that has a narrow range (e.g., minimum=1 through maximum=10) might be represented as a value from 1 to 10; however, a parameter that has a wide range (e.g., minimum=1 through maximum=10,000,000,000) might be represented as (for example) log₁₀ of the given value. In some cases a compression shape (e.g., a continuous non-linear curve or a non-continuous piecewise planar surface) might be applied to a range so as to process parameter values for comparison to other parameter values.

Once the three different types of parameters have been prepared for comparison, they can be projected onto respective three different spider charts. One of ordinary skill in the art can now recognize that the spider charts can be superimposed. To explain carrying out of such superposition, consider the three torsion-related parameters: (1) a torsion limitation 306 deriving from system characterization, (2) a rotational movement 320 that arises from actuation of a motor, and (3) measured external torsion force 328 that arises from aspects of the environment as they act on the robot. Strictly as one example, observe that the shown value of the external torsion force is very nearly the same (normalized) value of the torsion limitation. In this case the desired actuation corresponds to an actuation signal that adds very little or no additional torsional force.

As another example, observe that the value of the shown cycle rate measurement 330 is far less than the (normalized) value of the shown cycle rate demand 322. Moreover, neither the cycle rate measurement nor the cycle rate demand is in excess of cycle rate limitation 308. In this case, the actuated cycle rate is within the given cycle rate limitation. As a still further example, consider the scenario where ongoing planning signals specify application of actuated flexural force 324. The plotted value of that actuated flexural force is within the bounds of the flex limitation 310. It would thus be acceptable to apply the shown actuated flexural force only if the environment were not also applying appreciable amounts of external flexural forces 332.

Again, once the three different types of parameters have been prepared for comparison, they can be plotted onto a respective three different spider charts, and those three different spider charts can undergo superposition analysis where the lesser of respective values from any of the aforementioned three different types of parameters results in a projection that is deemed to comport with the given limitations. This plotting of three different spider charts can be accomplished by the shown multivariate projection module 336₀. In the shown example, operation of multivariate projection module 336₀ produces the shown resulting multivariate guaranteed safe projection 338.

In many cases, limitations such as the foregoing torsion limitation, even if continuously observed across all points in time, may not guarantee safety under all possible circumstances. This is especially true in dynamically-changing scenarios where a multitude of sensors are streaming real-time environmental data that are to be compared with streaming environmental measurements that represent ongoing changes in the environment and/or the juxtaposition of the robot with its environment. One mechanism to guarantee safe operation is to observe still further safety limitations. Such further safety limitations may come into play when sensor data is known to be merely an estimate, and/or when sensor data is delivered late or is otherwise temporarily not available for safety calculations. Example uses of these further safety limitations as inputs to a multivariate projection module are shown and described hereunder.

As shown, the embodiment of FIG. 3B includes a series of robotic safety constraints 114 that are ingested by multivariate projection module 336₀. One outcome of implementing this safe behavior guarantee technique is a spider chart such the shown guaranteed safe projection, which can in turn be used to modify planning signals (e.g., any of the shown planning signals of ongoing planning signal stream 305) to cause a robot to operate safely. As shown, the robotic safety constraints may be expressed in normalized forms (e.g., as normalized values 334) and/or may include further safety limits (e.g., alpha safety limit 335) that correspond to respective incoming signals (e.g., alpha signal 362) and/or may correspond to limits that are received from other sources (e.g., alpha limit 360 as received from system characterization module 304) and/or may correspond to measured environmental data (e.g., alpha measurement 363).

Robotic safety constraints for guaranteeing safe robot behavior may be expressed as a static limitation (e.g., no more than 100 foot-pounds of torque), or robotic safety constraints for guaranteeing safe robot behavior may be expressed as a formula (e.g., Torque_{TOTAL}=Torque_{SOURCE1}+Torque_{SOURCE2}), or robotic safety constraints for guaranteeing safe robot behavior may be expressed as logic (e.g., IF this THEN that), or as an algorithm (e.g., “Except during takeoff, do not allow Torque_{SOURCE1} to be greater than 90 foot-pounds of torque”).

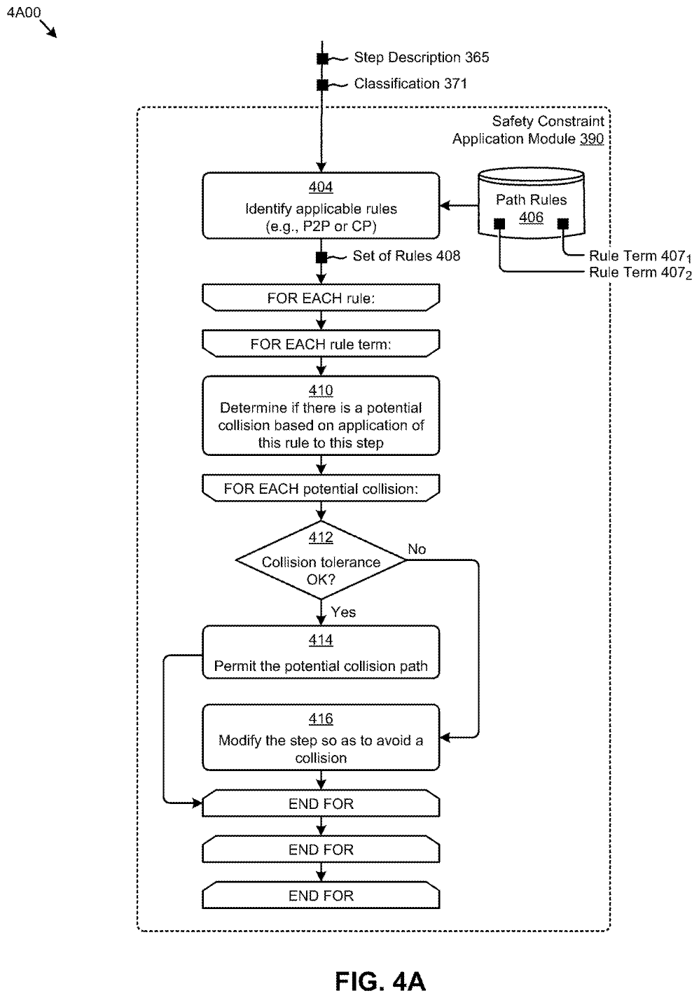

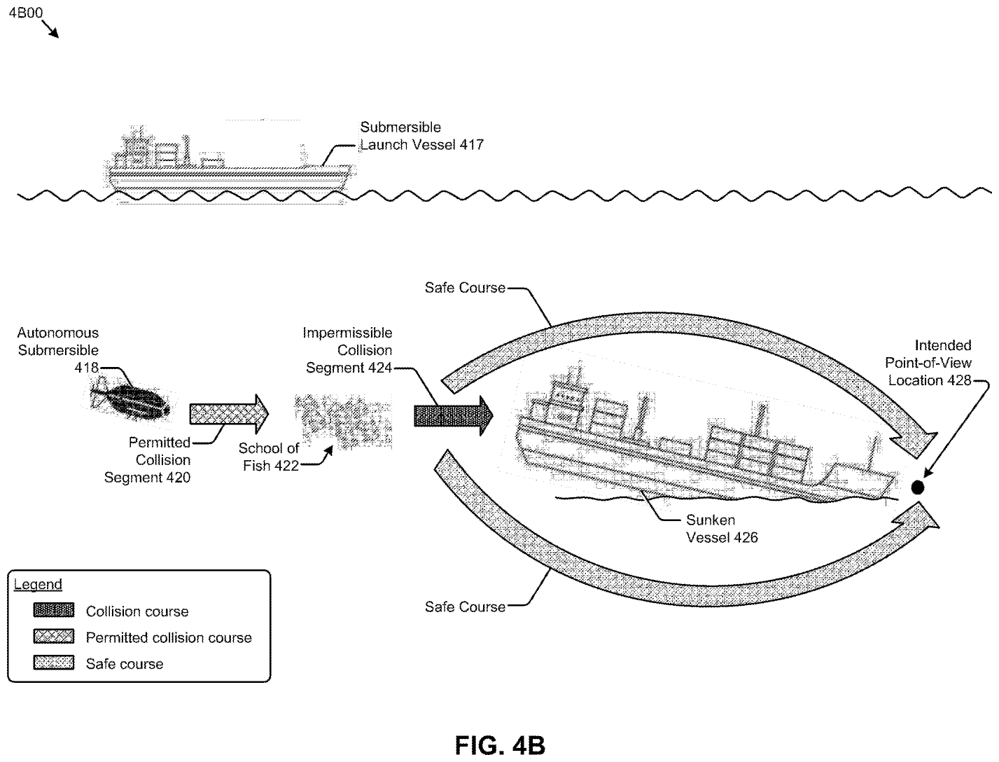

The foregoing discussions refer to uses of robotic safety constraints for guaranteeing safe robot behavior. One possible advance in techniques for generating such robotic safety constraints comprehends the notion of collision tolerance. One way to implement collision tolerance is shown and described as pertains to FIG. 4A.

FIG. 4A depicts an example collision tolerance processing flow as used in systems that transform natural language output of LLMs into robotic control signals that comport with known-safe robotic behavior. As an option, one or more variations of collision tolerance processing flow 4A00 or any aspect thereof may be implemented in the context of the architecture and functionality of the embodiments described herein and/or in any environment.

The figure is being presented to illustrate how a step description (e.g., step description 365 comprising a portion of a response resulting from prompting an LLM) can be considered with respect to any collision tolerance rules. More specifically, the figure is being presented to break down the application of collision tolerance into an algorithm that can be carried out by a computer. Still more specifically, the figure is being presented to explain how collision tolerance rules can be expanded into constituent terms, and how each term can be individually considered with respect to collision tolerance.

Any number of rules can be applied to a given incoming instance of step description 365. As shown, step 404 serves to identify a set of rules 408 that are drawn from path rules 406 based on the type or classification 371 of the incoming instance of step description 365. In this implementation, nested FOR EACH loops serve to perform operations over each individual rule of the set of rules 408, and further to perform a set of operations over each term (e.g., rule term 407₁, rule term 407₂) of a particular rule.

To illustrate, suppose the step description carries the semantics of “Move the articulator arm from point A to point B.” Now, further consider that the set of rules includes a rule that says, “Except when overridden, define articulator arm movements using anthropologically-accurate motions for elbow and wrist joint.” In this illustrative case, there are two terms: a first term pertaining to the elbow joint, and a second term pertaining to the wrist joint. Each term is considered, either individually, or together in combination.

As shown, step 410 serves to determine if there are potentials for collisions when carrying out “[ . . . ] anthropologically-accurate motions for elbow and wrist joints.” A potential for a collision might happen due to motion predicted by the planning signals (e.g., the robot arm could potentially collide with another member of the robot itself). Additionally or alternatively, a potential for a collision might happen due to relative motion predicted by the planning signals when considered with respect to a predicted motion of something in the environment. For example, a planned path of a robotic arm might be on a collision path with the arm of an adjacent robot. In this case, a collision would not be tolerated (e.g., as deemed by taking the “No” branch of test 412). Even though the foregoing rule specifies use of “[ . . . ] anthropologically-accurate motions for elbow and wrist joints,” that rule might be overridden by collision avoidance processing (step 416). Alternatively, rather than overriding a rule by collision avoidance processing, the potential collision might be tolerated—at least at that particular moment in time.

Recall that there is an ongoing stream of planning signals, and moreover that there is an ongoing stream of environmental sensor measurements. Accordingly, it can happen that a first time processing of step 410 detects there to be a potential collision, whereas at a second, later time, a second pass through the processing of step 410 detects that there is no longer that same potential collision.

Similarly, it can happen that a potential collision need not be remediated at that moment in time. For example consider the case when two terrestrial vehicles are approaching each other while going in different directions through a curve. There are many moments when the two vehicles are on a collision course with each other, however evasive maneuvers are not (yet) needed by either vehicle. The shown step 410 can be configured to consider a variety of possibilities, including, (1) consideration of a straight line progression of motion based on the most recent two measurements, or (2) consideration of a continuous curve-fitted progression of motion based on the most recent two measurements, or (3) some other predictions based on any available data and using any known prediction techniques. Accordingly, step 414 might at least temporarily permit planned robotic maneuvering in spite of the potential collision path.

The foregoing written description covers merely a small subset of possible scenarios under which predicted collisions might be (at least temporarily) tolerated. There are other scenarios where collision tolerance considers aspects of the environment. One such scenario where certain collision courses are tolerated based on consideration of aspects of the environment is shown and described as pertains to FIG. 4B.

FIG. 4B depicts an example autonomous vehicle control system use case that illustrates the utility of autonomously permitting certain collision courses. As an option, one or more variations of autonomous vehicle control system use case 4B00 or any aspect thereof may be implemented in the context of the architecture and functionality of the embodiments described herein and/or in any environment.

The figure is being presented to illustrate one scenario where a particular type of autonomous vehicle's control system is configured to operate in a corresponding particular environment. Specifically, the figure is being presented to illustrate collision tolerance as applies to how a submersible type of autonomous vehicle is operated underwater.

As shown, autonomous submersible 418 is given a mission to move to the bow of the sunken vessel 426 and send video to submersible launch vessel 417. One of several lower-level steps to accomplish this mission might be to navigate to a given intended point-of-view location. In carrying out this lower-level step (e.g., to navigate to intended point-of-view location 428) it can happen that, in this underwater environment, there is a school of fish 422. A naive execution of this lower-level step (e.g., to navigate to intended point-of-view location 428) might avoid “collision” with the school of fish, thus hindering progress toward achievement of the mission, possibly even disabling the autonomous submersible for a long period of time (e.g., disabling the autonomous submersible for as long as the school of fish are detectably present on the path to the intended point-of-view location). To remediate this, one or more collision tolerant path rules might be defined to cover the predictable happenstance in this underwater environment that there will be fish present.

As can be seen, when a particular type of autonomous vehicle's control system is configured to observe collision tolerance in a particular environment, there can be a permitted collision segment 420 at the same time, and in the same environment, as when there is an impermissible collision segment 424.

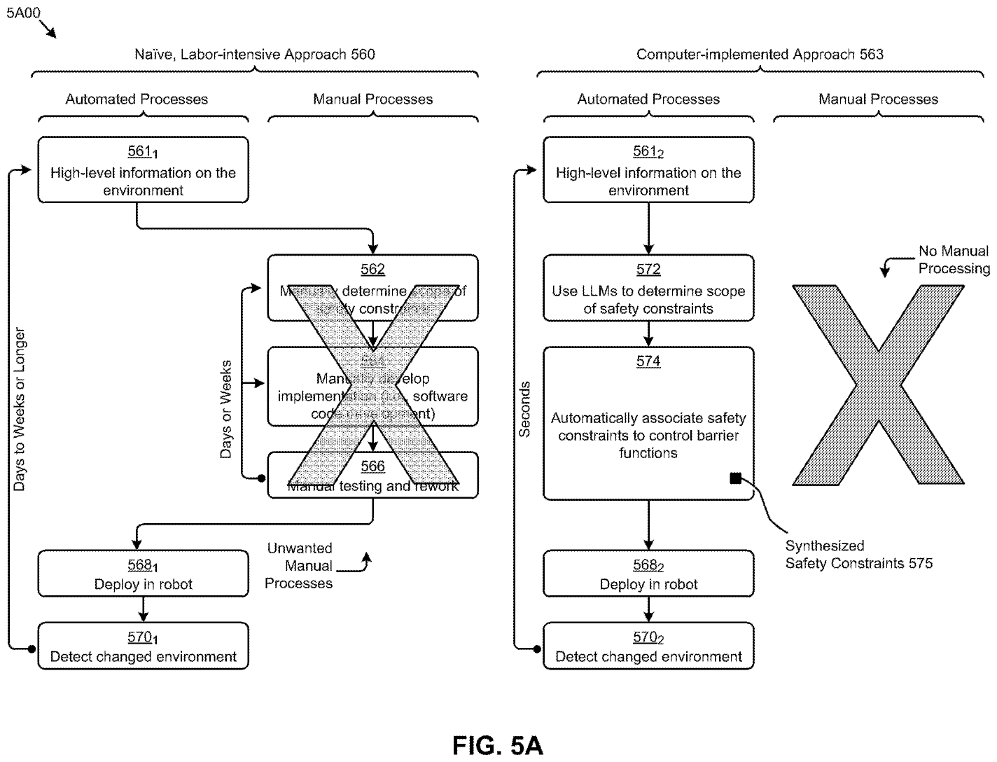

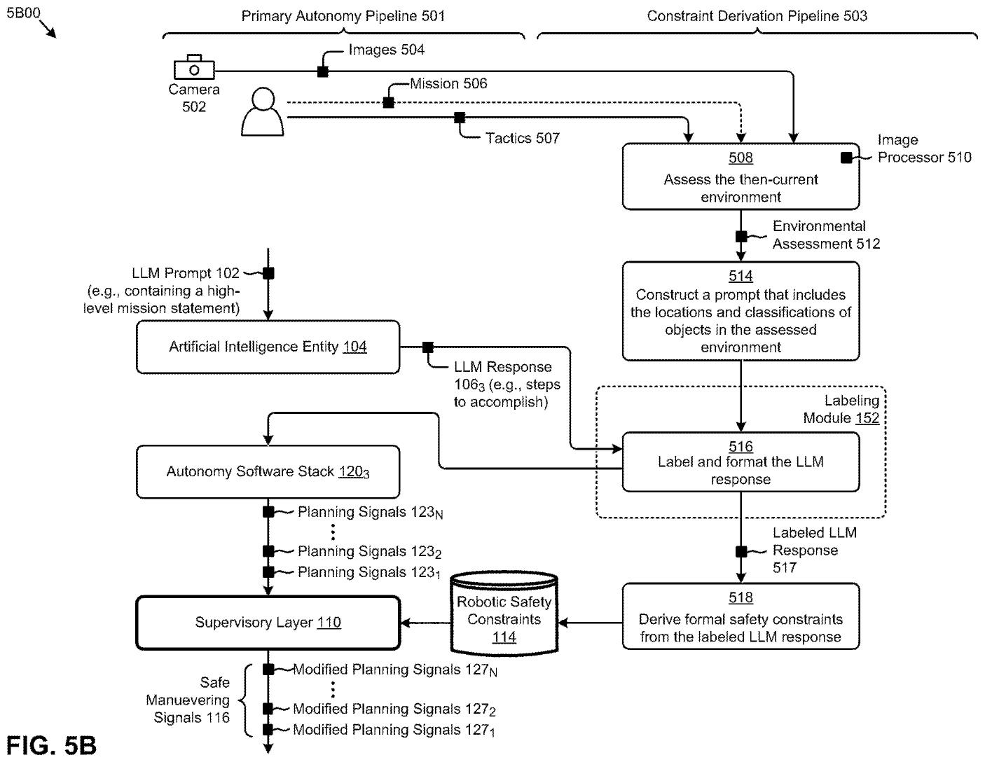

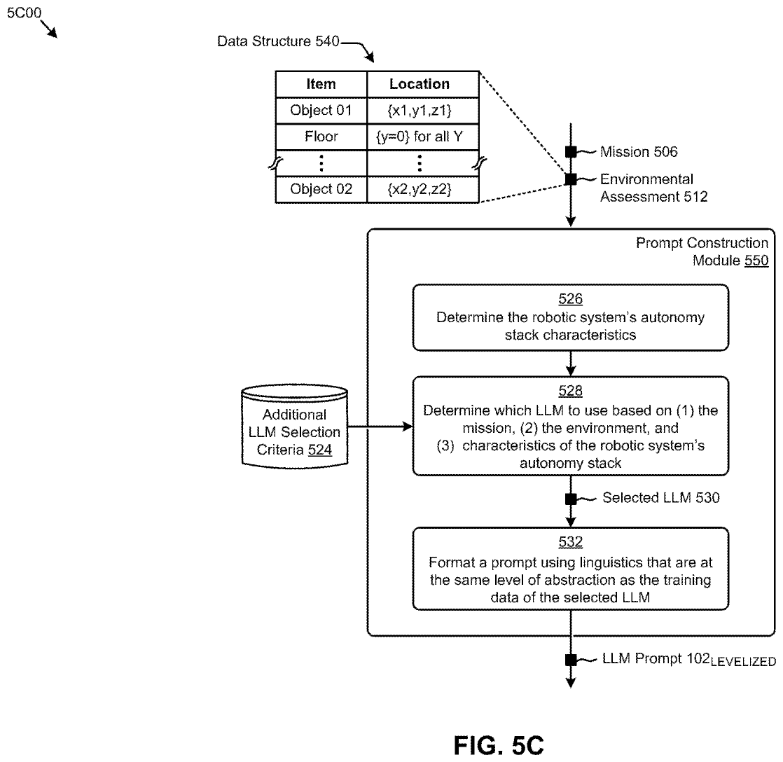

Much of the foregoing written description pertains to systems that observe pre-codified sets of robotic safety constraints, however in the context of systems that transform step-oriented LLM outputs into safety constraints, it is desirable to include robotic safety constraints that are formed dynamically—that is, derived in real-time based on contents of an LLM response from an AI entity. Reliance on manual intervention is to be eschewed. One possible way to address manual intervention so as to reduce or eliminate reliance on manual processes is shown and described as pertains to FIG. 5A.

FIG. 5A contrasts a naïve, labor-intensive approach with a computer-implemented approach. The figure is being presented to illustrate how manual processes can be eliminated through practice of the herein-disclosed techniques.

To explain, when deploying robotic systems in new environments, robotic safety constraints need to be identified, codified and validated before deployment of the robot(s) into a new environment. Legacy approaches are labor intensive, often involving multiple manual techniques (e.g., hand-coding of software, manual testing, and manual deployment, etc.). In contrast, the techniques disclosed herein provide a way to fully automate the identification, codification, and validation of robotic safety constraints, thus saving valuable resources and time and thus enabling more rapid deployment of robotic systems. In fact, using the techniques disclosed herein it is possible to form and deploy robotic safety constraints fully automatically-even in dynamically changing environments. That is, robotic safety constraints can be generated and deployed fully automatically and in real-time by processing LLM responses from one or more AI entities. Differences between the foregoing labor intensive approaches for dealing with robotic safety constraints and the disclosed computer-implemented approaches for dealing with robotic safety constraints are shown and described as pertains to FIG. 5A.

Specifically, FIG. 5A contrasts a naïve, labor-intensive approach 560 (e.g., left side of FIG. 5A) with a computer-implemented approach 563 for generating and deploying robotic safety constraints. As can be seen, labor-intensive approach 560 includes several unwanted manual processes, each of which demand a significant amount of manual labor and each of which at least potentially incurs a significant amount of calendar time to accomplish the corresponding manual processes. The undesirability of the foregoing manual processes involved in the labor-intensive approach 560 is illustrated by the stippled “X” on the left side of FIG. 5A.

In contrast, the computer-implemented approach shown on the right side of FIG. 5A takes a completely different approach that includes a single straightforward pipeline, which does not rely on any manual processing. As regards to generating and deploying robotic safety constraints fully automatically, and in real time, it can be seen from the illustration that traversal of the processing loop within the computer-implemented approach incurs only seconds of real time latency, whereas traversal of the loop through the labor-intensive approach 560 incurs latencies on the order of days (or weeks, or sometimes even longer).

To explain in still more detail, although the computer-implemented approach shown on the right side of FIG. 5A shares several identical or similar steps with the naïve, labor-intensive approach shown on the left side of FIG. 5A (i.e., step S61₁ is analogous to step S61₂, step S68₁ is analogous to step S68₂, and step S70₁ is analogous to step S70₂) it can be seen that the computer-implemented approach shown on the right side of FIG. 5A does not rely on manual determination of the scope of safety constraints (step 562), nor does the computer-implemented approach shown on the right side of FIG. 5A rely on manual software development (e.g., step 564), nor does the computer-implemented approach shown on the right side of FIG. 5A rely on any manual testing and rework (step 566). Instead, the computer-implemented approach shown on the right side of FIG. 5A uses one or more LLMs to determine the scope of safety constraints (step 572), which safety constraints are then associated with control barrier functions (step 574). In some cases, the performance of step 574 includes synthesis of safety constraints based on the information provided by an LLM. More specifically, acts pertaining to automatically associating safety constraints to control barrier functions (step 574) might include formation, codification and/or other operations for synthesis of safety constraints. Such synthesized safety constraints 575 are in turn associated with control barrier functions. It can be easily recognized by one of skill in the art that these last-mentioned automated steps (i.e., step 572 and step 574) are fully automatable so as to be performed by a computer. On the other hand, It can be easily recognized by one of skill in the art that the foregoing mentioned automated steps (i.e., step 572 and step 574) could be configured to aid a human operator through computer-aided assistance. For example, step 527 can be configured to output a human-readable list of candidate safety constraints, which a human can then consider, either singly or in combination with respect to entries in a library of control barrier functions.

### Dynamic, Fast-changing Environments

As is easily understood by one of skill in the art, the environment in which a robot operates can change very quickly. In some cases, an environment of interest changes completely within a moment's time. Consider a robot drone that is flying northward, but then make a U-turn to fly southward. In this case, in a first moment the environment of interest is north-facing, whereas in a second moment, the environment of interest is south-facing. As such, it is desirable to generate robotic safety constraints dynamically, where new sets of robotic safety constraints are derived automatically and in real-time based on contents of an LLM response from an AI entity. One possible way to implement dynamic derivation of robotic safety constraints based on LLM responses from an AI entity is shown and described as pertains to FIG. 5B.

FIG. 5B depicts an example implementation of a robotic safety constraint derivation technique as used in systems that transform step-oriented LLM outputs into safety constraints. As an option, one or more variations of robotic safety constraint derivation technique 5B00 or any aspect thereof may be implemented in the context of the architecture and functionality of the embodiments described herein and/or in any environment.

The left side of FIG. 5B presents a primary autonomy pipeline 501, whereas the right side of FIG. 5B presents a constraint derivation pipeline 503. Both pipelines can operate concurrently, independently, and/or in a function-wise interleaved manner (as shown). The constraint derivation pipeline is being presented to show at least one way to implement robotic safety constraint derivation where step-oriented LLM outputs are labeled and formatted (e.g., at step 516), and then transformed into derived safety constraints. Such derived safety constraints are in turn used in systems that ensure safe execution of AI-generated robotic commands.

As shown, processing in the primary autonomy pipeline begins when an LLM prompt 102 is presented to artificial intelligence entity 104. Output from the artificial intelligence entity includes an LLM response 1063 that is then provided to one or more operational units of labeling module 152. As can be seen by inspection of this embodiment, execution of operational units of labeling module 152 is carried out after receiving outputs from artificial intelligence entity 104 and before commencing with processing of the supervisory layer 110. In this embodiment, performance of steps within, or directed by, labeling module 152 results in a labeled LLM response 517. The primary autonomy pipeline is merely one possible partitioning choice that is presented as a non-limiting illustrative example.

In this embodiment, the constraint derivation pipeline performs various functions on behalf of the primary autonomy pipeline. Specifically, and as shown in this example partitioning, the constraint derivation pipeline includes steps for: (1) performing prompt engineering iteratively until the LLM response returned is in a step-wise form that can be labeled (e.g., when the steps given in the LLM response are at the desired level of detail), and (2) loading derived formal safety constraints into the robotic safety constraint database. The computer code that performs the function of performing prompt engineering is configured such that the LLM is offered an information-rich prompt. Specifically, a prompt is enriched with sufficient information and details in the prompt to cause the LLM to return a commensurately detailed LLM response. Then, given such a commensurately detailed LLM response, aspects of the LLM response are labeled in a manner that facilitates derivation of formal safety constraints from the labeled LLM response (step 518).

Those of ordinary skill in the art will recognize that an LLM will return responses at substantially the same level of abstraction as is given in the prompt. Also, those of ordinary skill in the art will recognize that formal constraints are mathematical constructs that are at a low level of abstraction. This presents a mismatch that needs to be addressed. To illustrate the foregoing mismatch, an LLM counter example is presented in Table 6. To contrast, Table 7 presents an improved LLM prompt having been enriched with sufficient information and details in the prompt so as to cause the LLM to return a commensurately detailed LLM response.

TABLE 6
LLM counter example

| Index | Text |
|---|---|
| LLM | There is a remote controlled car on the ground. It needs to |
| Prompt | get to the other side of the room, but there are two objects |
| (Mission | in the room blocking its path. One object is a vase and the |
| Statement) | other object is a blanket. Tell me how to get to the remote |
| | controlled car to the other side of the room. |
| LLM | To get the remote controlled car to the other side of the |
| Response | room while avoiding the vase and the blanket, follow these |
| (Solution) | steps: |
| | a. First, pick up the remote controlled car. |
| | b. Approach the vase and check if it is heavy or fragile. |
| | If it's lightweight and not fragile, it can be simply moved |
| | to the side to create a clear path. |
| | c. If the vase is too heavy or too fragile to move, then find a |
| | way to maneuver around it, making sure not to bump into it. |
| | d. Now to address the blanket: If the blanket is lying flat, |
| | carefully go over it, taking care not to trip on it. |
| | e. If the blanket is folded or bunched up, smooth it out or |
| | pick it up and move it out of the way. |
| | f. While carrying the remote controlled car, safely reach the |
| | other side of the room by making sure not to encounter any |
| | other obstacles. |
| | g. Finally, while remaining on the other side of the room, |
| | put the remote controlled car down. |

As can be seen, the LLM response does indeed return a step-wise solution to accomplish the given mission 506. However, it does so in a way that evades the possibility of deriving relevant safety constraints that bound a robot's behavior. What is needed is a more detailed prompt, one example of which is presented in Table 7.

Before discussing Table 7, it is instructive to note that step 508 includes an image processor 510, which is able to produce an environmental assessment 512 with or without consideration of any mission statement. For example, an environmental assessment might be generated by considering images 504 as produced by camera 502 (e.g., images of the environment of interest). Any known techniques (e.g., edge detection, 3D dimensional analysis, object classification, etc.) can be used to generate information about the environment that can, in turn, be used to enrich the prompt offered to the LLM. Moreover such an environmental assessment can be generated in real time (e.g., at least as fast as the rate of the imager device of the camera). It should be noted that there are many real-word situations where real-time imaging is carried out even in absence of a mission statement. Strictly as one example, there are many real-world situations where a human operator is operating robotic controls-leading to the situation where the robot cannot know the mission (e.g., some final state), but merely tactics 507 or steps (e.g., “go left”, “go right”, etc.) that putatively lead to accomplishment of the mission in the mind of the human operator.

In this particular embodiment, selected information about the environment is given in the latter portion of the engineered LLM prompt. Specifically, the prompt text corresponding to index 6 of Table 7 is an example of information about the environment that can be generated automatically through use of a camera and an image processor—and with or without any knowledge of an intended mission or outcome.

TABLE 7
Engineered LLM prompt

| Index | Prompt Text |
|---|---|
| 1 | Pretend you are a safety supervisor for a robotics company |
| | named LLL. You have been tasked with maintaining the |
| | physical integrity of the robots as well as upholding the 3 laws |
| | of robotics: |
| | a. A robot may not injure a human being or, through inaction, |
| | allow a human being to come to harm. |
| | b. A robot must obey orders given to it by human beings except |
| | where such orders would conflict with the First Law. |
| | c. A robot must protect its own existence as long as such |
| | protection does not conflict with the First or Second Law. |
| 2 | As an LLL employee, you will be provided with a formatted |
| | scene description, a goal specification, and a description of the |
| | robot platform. Your task is to produce a sorted list of the |
| | objects in the scene in YAML format along with a safety rating |
| | for each object. The first object in the list is to be the least safe |
| | to come into contact with, while the last object is deemed to be |
| | the safest to come into contact with. |
| 3 | Before outputting the formatted JSON list, you are to produce: |
| | a. A description of safety considerations for the robot platform. |
| | b. A description of safety considerations pertaining to the |
| | environment. |
| | c. A description of how the robot platform and its interactions |
| | with respect to the environment are impacted by safety |
| | considerations for each object in the scene. This description |
| | must include an explanation of the safety rating you assign to |
| | each object. |
| 4 | At the end of the chat, you are to include the string, |
| | “FORMATTED YAML STRING:” Next, you are to produce |
| | the formatted YAML string of the sorted objects with their |
| | associated safety index. Notice that the example scene |
| | description provided offers a general idea of the expected |
| | output, but the example scene description provided here is not |
| | as thorough or detailed as the actual outputs that are expected |
| | from you. |
| 5 | The following is an example of a formatted scene description: |
| | Robot: ″AWS DeepRacer RC car with 3D printed camera |
| | mount.″ |
| | Environment : |
| | ″human″ |
| | ″blanket″ |
| | ″chair″ |
| | ″table″ |
| | ″door″ |
| | ″ball″ |
| | ″sandal″ |

As can be seen from inspection of the foregoing LLM prompt of Table 7, the LLM is presented with ground rules (e.g., as given in the prompt text corresponding to index 1 of Table 7). Further, the LLM is presented with a task statement (e.g., as given in the prompt text corresponding to index 2 of Table 7), as well as various requirements for the desired LLM output (e.g., as given in the prompt text corresponding to index 3, index 4, and index 5 of Table 7).

When a prompt having the degree of detail and specificity is constructed (e.g., at step 514) and provided to an LLM (e.g., to artificial intelligence entity 104), the LLM response is commensurately detailed and specific. Table 8 breaks down the LLM response that is returned by the LLM.

TABLE 8
LLM response

| Index | LLM Response Text |
|---|---|
| 1 | a. Robot safety considerations: The AWS DeepRacer RC car is |
| | a small, lightweight robot. This means it is unlikely to survive |
| | in a collision with rigid objects. It is top heavy because of the |
| | camera mount. This means it is also likely to become disabled if |
| | it tries to run over an uneven surface. |
| 2 | b. Task safety considerations: The robot will be moving at a |
| | moderate speed for its size and likely will have to navigate |
| | around objects in the scene in order to produce imagery (e.g., |
| | LiDAR scans). Tumbling over objects most likely will result in |
| | degraded image capture performance, and thus will result in a |
| | less accurate map. |
| 3.1 | c. Scene object safety considerations would be: |
| | (i) The human is the least safe object in the scene and should be |
| | avoided at all costs. The person could be injured if they tripped |
| | over the robot if it were to get near them. This would justify |
| | giving the human a score of 0.0 safety index. |
| 3.2 | (ii) The blanket is a relatively safe object for the robot to come |
| | into contact with because it is assumed that it is soft, |
| | lightweight, and unlikely to cause the robot to tip over. It is |
| | deformable, so even running over it may not result in large |
| | bumps for the robot to traverse. This would justify giving the |
| | blanket a score of 0.8. |
| 3.3 | (iii) The chair is not a safe object to come into contact with |
| | because it is rigid and could damage the robot and/or could |
| | cause the robot to tip over. This would justify giving the chair a |
| | score of 0.2. |

NOTE:
The remaining examples are omitted for brevity.

| | |
|---|---|
| 4 | FORMATTED YAML STRING: |
| | scene : |
| | object: ″human″ |
| | safety_index: 0.0 |
| | object: ″blanket″ |
| | safety_index: 0.8 |
| | object: ″chair″ |
| | safety_index: 0.2 |
| | object: ″table″ |
| | safety_index: 0.3 |
| | object: ″door″ |
| | safety_index: 0.0 |
| | object: ″ball″ |
| | safety_index: 0.8 |
| | object: ″sandal″ |
| | safety_index: 0.7 |

As can be seen by inspection of Table 8, the LLM response to the LLM prompt of Table 7 does indeed comport with the instructions of Table 7. Specifically, the LLM response as shown in index 4 of Table 8 follows the instructions (e.g., formatting requirements) provided to the LLM in the prompt (e.g., as given in index 4 Table 7). Moreover, the objects in the environment each have corresponding (i.e., have been labeled with) safety indexes, as requested.

The foregoing discusses labeling in particular formats, in this case the well-known YAML markup language and the well-known JSON notation language, however other languages or formats such as other markup languages can be supported. Moreover although the foregoing paragraphs emphasizes requesting that the LLM provide responses in accordance with some particular type or class of formatting, the LLM can be requested to provide any known environmental safety constraints and/or to provide any known controllable condition safety constraints. For example, an LLM might be prompted in a manner that requests an LLM response that includes dimensions of a room, which dimensions (e.g., dimensions in feet, etc.) inform safe operating distances from room features (e.g., distances in inches from walls or doorways, etc.), or the LLM can be requested to produce an LLM response that corresponds to various safe operation limits (e.g., “limit speed to less than 1 meter per second”) and/or that corresponds to controllable condition safety constraints (e.g., “velocity<1 meter per second”). Any such known environmental safety constraints and/or any such known controllable condition safety constraints as provided by the LLM are nevertheless checked by, and in accordance with the then-current configurations of the herein-discussed supervisory layer components.

### Further Prompts, Further Context

As is known in the art, an LLM uses context provided in the dialog. Accordingly, a further prompt might request the LLM to produce a step-wise solution to a robotic mission. Such a step-wise solution to a robotic mission as given by an LLM can sometimes be used as inputs to a robot autonomy software stack (autonomy software stack 120₃). Alternatively, a further prompt might request the LLM to produce a signal-wise solution to a robotic mission (e.g., where the LLM response includes planning signals (e.g., planning signals 123₁, planning signals 123₂, . . . , planning signals 123_{N}) in a format that is specified to the LLM.

Now that the safety constraints have been augmented (e.g., the robotic safety constraints 114 as enriched by the derived formal safety constraints of step 518), and having a set of planning signals, supervisory layer 110 can output a set of safe maneuvering signals 116 as a series of modified planning signals (e.g., modified planning signals 127₁, modified planning signals 127₂, . . . , modified planning signals 127_{N}). The robot can thus safely carry out its mission.

The foregoing description of FIG. 5B refers to prompt engineering. More specifically, the foregoing description of FIG. 5B includes step 514 that constructs a prompt with certain characteristics. The actual construction of such a prompt having certain characteristics depends on many factors. Moreover, as previously discussed, when a prompt having a high degree of detail and specificity is provided to an LLM, the LLM response will be commensurately detailed and specific. As such, this leads to the need for techniques that produce LLM prompts that are at a level of detail and specificity appropriate for a particular mission to be carried out within a particular environment.

FIG. 5C presents an example implementation of an environment-aware prompt engineering technique. Specifically, FIG. 5C shows how to construct a prompt that concurrently considers both a particular mission and how that particular mission can be carried out within that particular environment.

FIG. 5C depicts an example implementation of an environment-aware prompt engineering technique as used in systems that transform natural language output of LLMs into robotic control signals that comport with safety constraints. As an option, one or more variations of environment-aware prompt engineering technique 5C00 or any aspect thereof may be implemented in the context of the architecture and functionality of the embodiments described herein and/or in any environment.

As an initial consideration, and referring back to FIG. 5B, when constructing an LLM prompt that pertains to the relative safety of a mission, aspects of the environment can be collected by means of a camera that produces images, which in turn are analyzed with respect the object and anything else that might pertain to the bounds of robotic behavior as the robot carries out its mission. One example of a collection of environmental information (e.g., as collected by camera 502 and as analyzed by image processor 510) shown as environmental assessment 512, which in turn is depicted in an expanded form by data structure 540. The data structure has a column for structures and objects (e.g., the structure of the floor, object01, object02, etc.) that were identified by image analysis.

The data structure also includes a location (e.g., in three dimensions, x, y, and z) corresponding to each structure or object entry. Such an environmental assessment 512, in combination with mission 506, serves to inform prompt construction module 550. Step 526 serves to determine the robotic system's autonomy stack characteristics, which characteristics are then used in processing of step 528. In some cases, determination of said characteristics can be obtained using standardized application programming interfaces (APIs). In other cases, vendor-specific APIs are used to determine the robotic system's autonomy stack characteristics. In still other cases, step 526 is configured to determine the robotic system's autonomy stack characteristics by stimulating the robotic system's autonomy stack with sample stimulus, and then determining at least some representative ones of the stack's characteristics based on the stack's outputs to the provided stimulus. The determinations made in response to carrying out step 526 are used to inform step 528, which, in some embodiments, draw from additional LLM selection criteria 524.

As is known in the art, different LLMs are trained on different corpora of training data, and as such produce LLM responses that are drawn from their training data. Strictly as illustrative examples, an LLM that had been trained exclusively on high-level step-wise approaches to accomplishing a mission will return high-level stepwise solutions, whereas an LLM that had been trained exclusively on low-level planning signal approaches to accomplishing a mission will return solutions based on a series of low-level planning signals. Accordingly, step 528 is configured to select an LLM (e.g., selected LLM 530) that has been trained using training data of a desired level.

For example, as suggested above, the selection may depend, in whole or in part, on characteristics of whatever autonomy software stack is being employed in the overall processing flow of the robotic system. Continuing the foregoing example, if the autonomy software stack is being employed and the overall processing flow of the robotic system is able to comprehend step-wise codifications of missions, then an LLM that has been trained on high-level step-wise approaches might be selected, whereas if the autonomy software stack is being employed and the overall processing flow of the robotic system is absent or of limited capability, then an LLM that has been trained on low-level planning signals might be selected.

Once a particular LLM, and possibly a particular version of the selected LLM, has been determined, the prompt construction module can construct an LLM prompt that is at the same level of abstraction as is the training data of the selected LLM (step 532). Such an LLM prompt (e.g., LLM prompt 102_{LEVELIZED}) is made available for downstream processing.

The foregoing written description pertains to merely the shown and discussed example embodiments. Many variations are possible, for example the many variations as given in the appended claims.

### ADDITIONAL EMBODIMENTS OF THE DISCLOSURE

### Instruction Code Examples

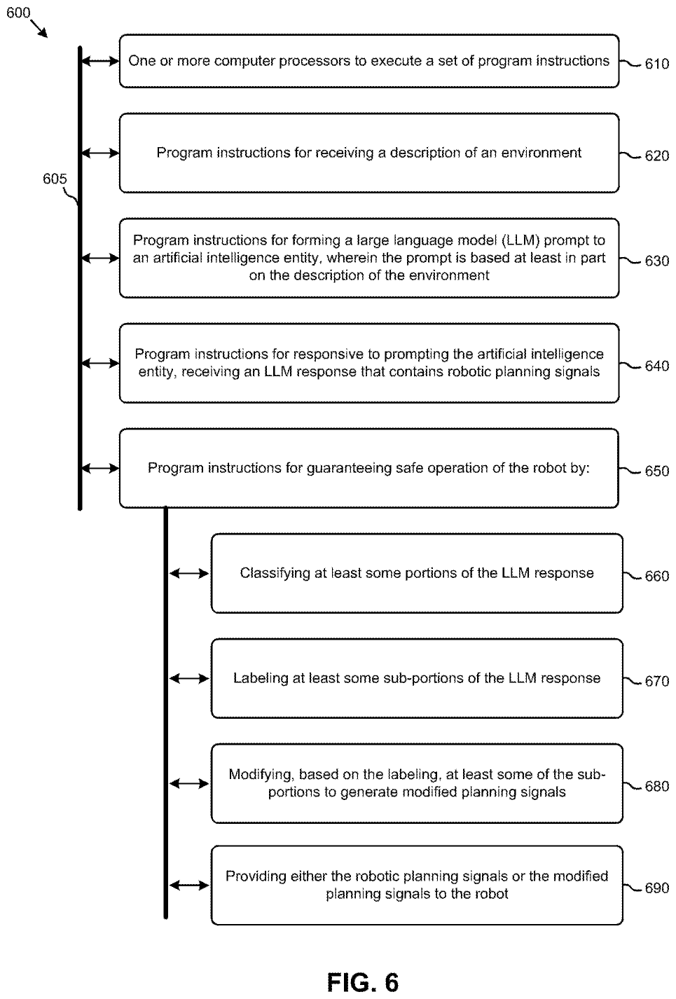

FIG. 6 depicts system 600 as an arrangement of computing modules that are interconnected so as to operate cooperatively to implement certain of the herein-disclosed embodiments. This and other embodiments present particular arrangements of elements that, individually or as combined, serve to form improved technological processes that address deficiency of autonomous vehicles to ensure safe behavior while pursuing step-oriented tasks. The partitioning of system 600 is merely illustrative and other partitions are possible. As an option, system 600 may be implemented in the context of the architecture and functionality of the embodiments described herein. Of course, however, system 600 or any operation therein may be carried out in any desired environment. The system 600 comprises at least one processor and at least one memory, the memory serving to store program instructions corresponding to the operations of the system. As shown, an operation can be implemented in whole or in part using program instructions accessible by a module. The modules are connected to a communication path 605, and any operation can communicate with any other operations over communication path 605. The modules of the system can, individually or in combination, perform method operations within system 600. Any operations performed within system 600 may be performed in any order unless as may be specified in the claims. The shown embodiment implements a portion of a computer system, presented as system 600, comprising one or more computer processors to execute a set of program code instructions (module 610) and modules for accessing memory to hold program code instructions to perform: receiving a description of an environment (module 620); forming a large language model (LLM) prompt to an artificial intelligence entity, wherein the prompt is based at least in part on the description of the environment (module 630); responsive to prompting the artificial intelligence entity, receiving an LLM response that contains robotic planning signals (module 640); guaranteeing safe operation of the robot (module 650) by: classifying at least some portions of the LLM response (module 660); labeling at least some sub-portions of the LLM response (module 670); based on the labeling, modifying at least some of the sub-portions to generate modified planning signals (module 680); and providing either the robotic commands or the modified planning signals to the robot (module 690).

Variations of the foregoing may include more or fewer of the shown modules. Certain variations may perform more or fewer (or different) steps and/or certain variations may use data elements in more, or in fewer, or in different operations. Still further, some embodiments include variations in the operations performed, and some embodiments include variations of aspects of the data elements used in the operations.

### EXPERIMENTAL RESULTS

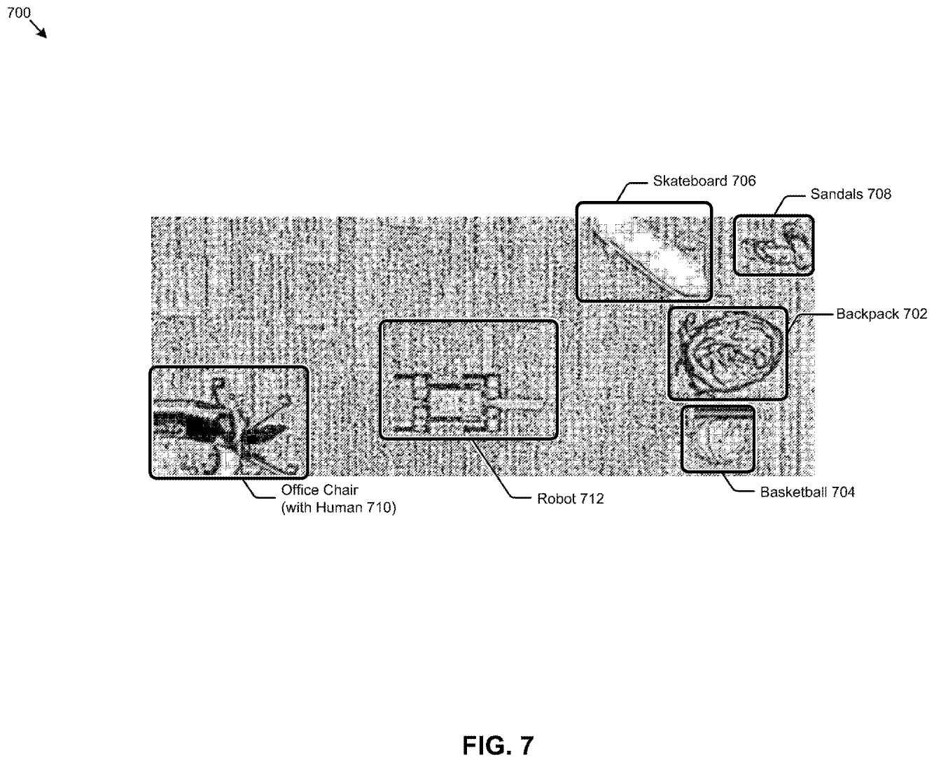

FIG. 7 depicts a physical setting 700 in which embodiments of the present disclosure can be practiced. Initial steps carried out in the experiment included: (1) setting-up of a camera in the physical setting from a vantage point above the scene, and (2) performing image segmentation and spatial perception to generate a list of all recognized shapes in the physical setting. In this experiment, the recognized shapes included backpack 702, basketball 704, skateboard 706, sandals 708, and a human 710 (by detection of a human elbow, keyboard, and other items). Each item in the list is associated with a possibly dynamic then-current location. The list of obstacles in the physical setting was fed to ChatGPT along with a prompt that required a response in a specified format. The ChatGPT AI entity returned a correspondingly formatted response, the contents of which response included a safety rating for each item. In this case the safety rating was a numeric value that varied between 0 (avoid at all costs) to 1 (does not matter at all). Given the aforementioned safety ratings (e.g., embedded within the ChatGPT response), a corresponding set of hierarchical control barrier functions (CBFs) were generated. The hierarchy was specifically tuned to ensure prioritization from most important CBF to least important CBF.

### Safe Behavior in a Dynamically-Changing Environment

Next, a human operator attempted to drive the robot 712 around within the bounds of the pre-imaged portions of the physical setting. The hierarchical CBFs in fact prevented the robot from touching obstacles. This was attempted multiple times, including multiple drive-arounds when the human operator purposely tried to “run over” an obstacle.

At a later time, when a human (or other safety-critical being or asset) arrived on the scene and attempted to purposely (i.e., for purposes of the experiment) walk into the robot, the human was prioritized over the inanimate objects on scene and the robot walked over the skateboard/basketball in order to avoid contact with the human.

When new objects (e.g., further obstacles) entered the scene, they were detected automatically, and a new prompt was generated and fed into the LLM. The LLM responded with an updated set of safety ratings, against which an updated set of hierarchical control barrier functions (CBFs) were generated.

The foregoing pertains to merely one experiment that was carried out in a particular environment. Safe operation in other environments having different characteristics is of course possible. In fact, the foregoing experiment was constructed merely to illustrate the generality of safe operation in a dynamically-changing environment. Additional experiment have been conducted where the supervisor is able to generate safe signals based on CBFs that are configured based on any one or more, or any combination of, speed, inertia, contact, including purposeful contact, and other kinematics, as well as actuator parameters, aspects of materials (e.g., hard, soft, elastic, brittle, etc.), and shapes.

### System Architecture Over View

### Additional System Architecture Examples

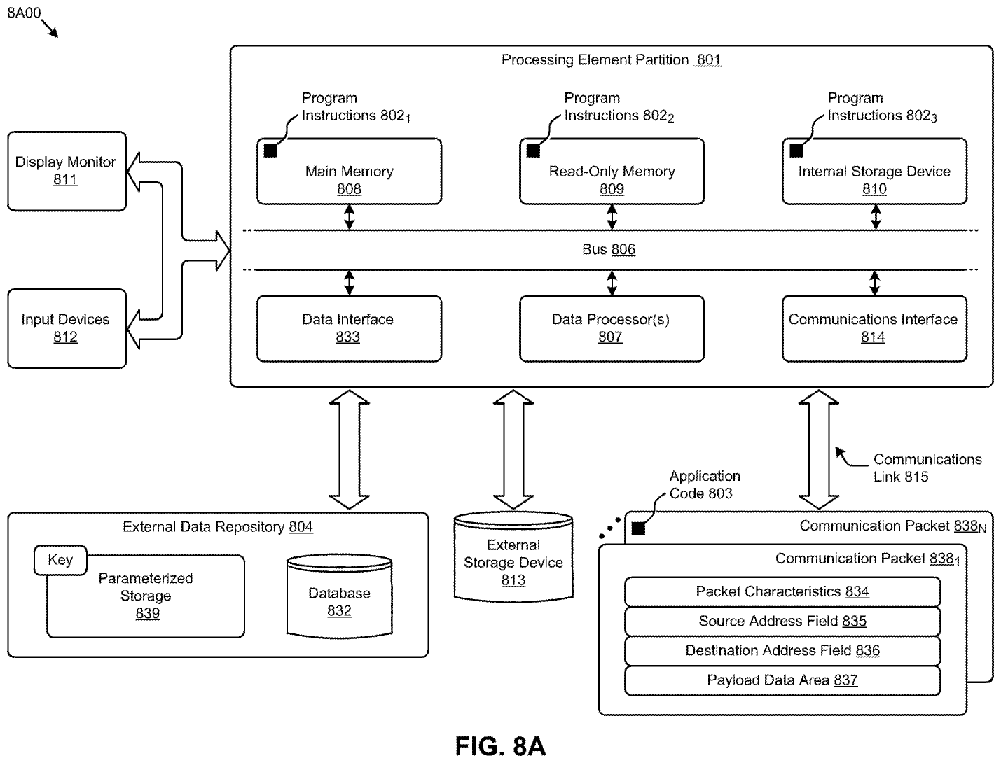

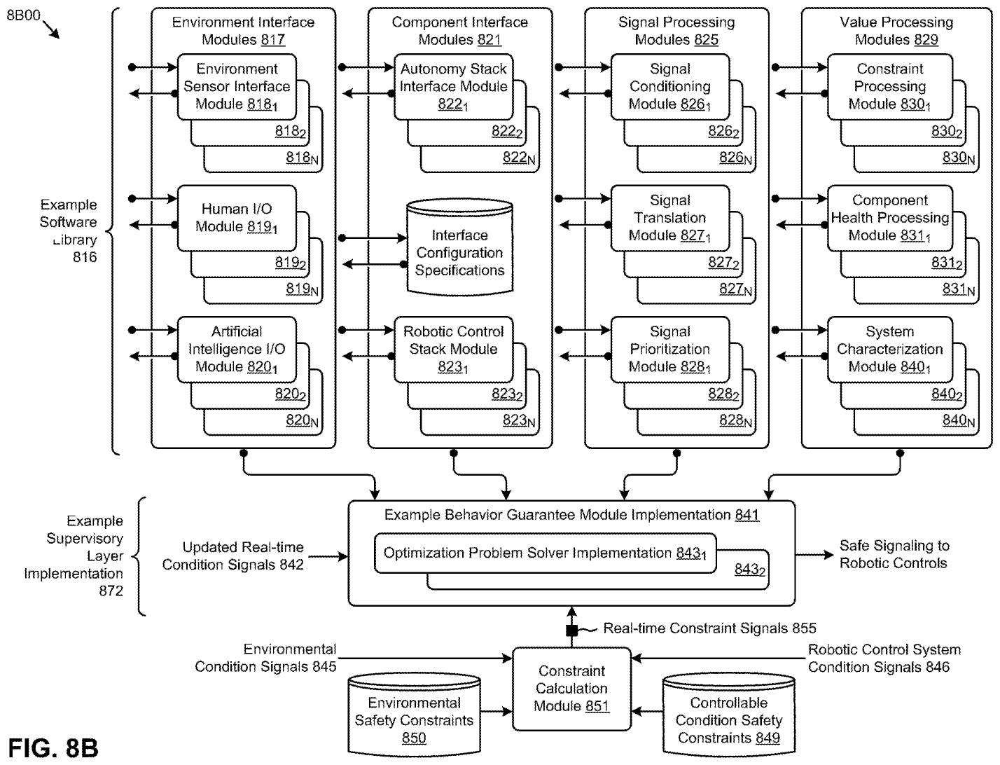

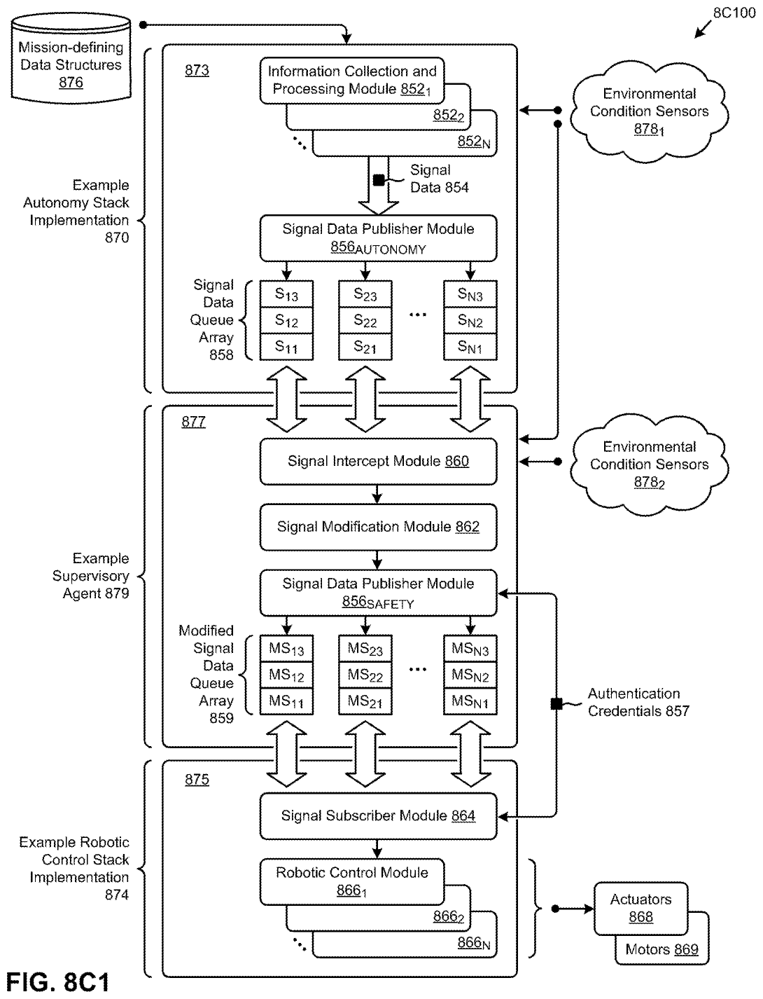

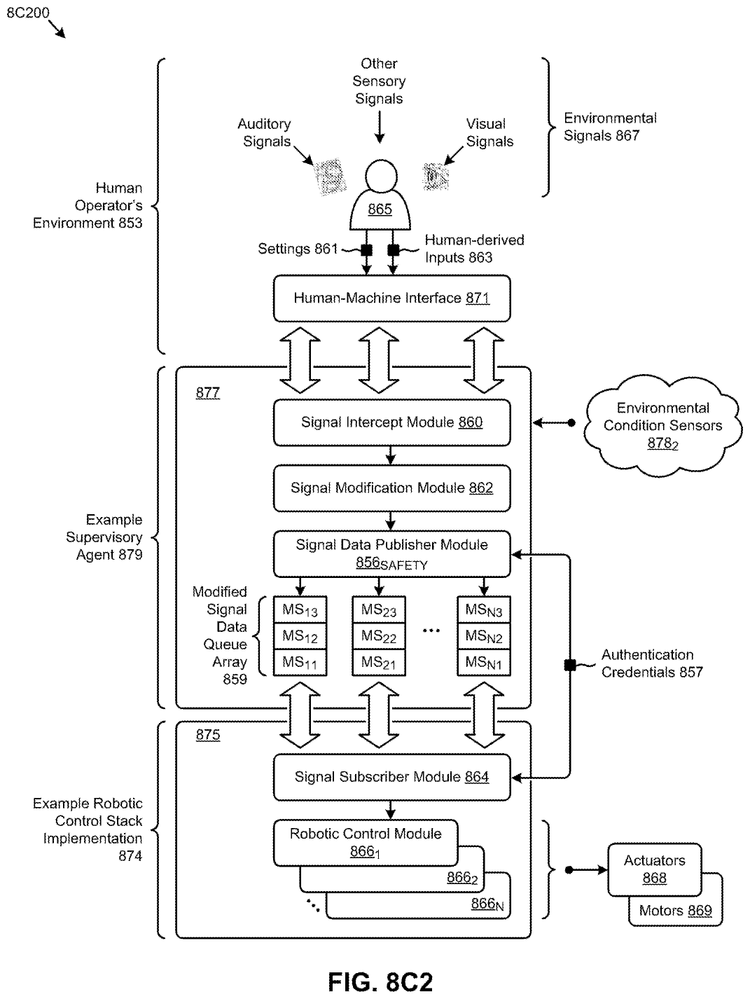

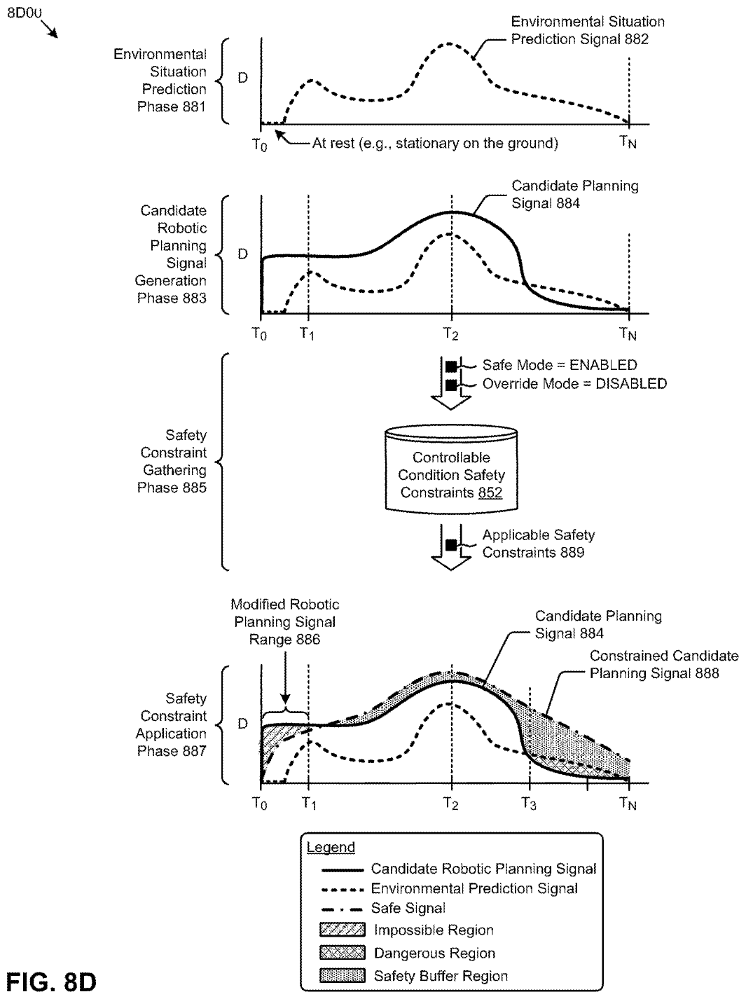

FIG. 8A depicts a block diagram of an instance of a computer system suitable for implementing embodiments of the present disclosure. Computer system 8A00 includes a bus 806 or other communication mechanism for communicating information. The bus interconnects subsystems and devices such as a central processing unit (CPU) or a multi-core CPU (e.g., data processor 807), a system memory (e.g., main memory 808 or an area of random access memory (RAM)), a non-volatile storage device or non-volatile storage area (e.g., read-only memory 809), a storage device that uses semiconductor memory or magnetic or optical technologies (e.g., internal storage device 810), a data interface 833, and a communications interface 814 (e.g., PHY, MAC, Ethernet interface, modem, etc.). The aforementioned components are shown within processing element partition 801, however other partitions are possible. Computer system 8A00 further comprises a display 811 (e.g., CRT or LCD), various input devices 812 (e.g., keyboard, cursor control, etc.), and an external data repository 804.

According to some embodiments of the disclosure, computer system 8A00 performs specific operations by data processor 807 executing one or more sequences of one or more program instructions contained in a memory. Such instructions (e.g., program instructions 8021, program instructions 8022, program instructions 8023, etc.) can be contained in, or can be read into, a storage location or memory from any computer readable/usable storage medium such as a static storage device or a disk drive. The sequences can be organized to be accessed by one or more processing entities configured to execute a single process or the sequences can be configured for execution by multiple concurrently running processing entities. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 8A00 performs specific networking operations using one or more instances of communications interface 814. Instances of communications interface 814 may comprise one or more networking ports that are configurable (e.g., pertaining to speed, protocol, physical layer characteristics, media access characteristics, etc.), and any particular instance of communications interface 814 or port thereto can be configured differently from any other particular instance or port. Portions of a communications protocol can be carried out in whole or in part by any instance of communications interface 814, and data (e.g., packets, data structures, bit fields, etc.) can be positioned in storage locations within communications interface 814 or within system memory, and such data can be accessed (e.g., using random access addressing, or using direct memory access (DMA), etc.) by devices such as data processor 807.

Communications link 815 can be configured to transmit (e.g., send, receive, signal, etc.) any type of communications packets (e.g., communication packet 838₁, . . . , communication packet 838_{N}) comprising any organization of data items. The data items can comprise a payload data area 837, a destination address field 836 (e.g., a destination IP address), a source address field 835 (e.g., a source IP address), and can include various encodings or formatting of bit fields to populate packet characteristics 834. In some cases, the packet characteristics include a version identifier, a packet or payload length, a traffic class, a flow label, etc. In some cases, payload data area 837 can comprise a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software (e.g., instructions stored in/on a non-volatile medium), or hardware that is used to implement all or part of the disclosure.

The terms “computer readable medium” or “computer usable medium” as used herein refer to any medium that participates in providing instructions to data processor 807 for execution. Such a medium may take many forms including, but not limited to, non-volatile media and volatile media. Non-volatile media includes, for example, optical or magnetic disks such as disk drives or tape drives. Volatile media includes dynamic memory such as RAM.

Common forms of computer readable media include, for example, a flash memory drive, a spinning hard drive, a floppy disk, a flexible disk, magnetic tape, or any other magnetic medium; a CD-ROM or any other optical medium such as punch cards, paper tape, or any other physical medium with patterns of holes; semiconductor memories such as RAM, PROM, EPROM, FLASH-EPROM, or any other memory chip or cartridge; or any other non-transitory computer readable medium. Such data can be stored, for example, in the shown external storage device 813, and/or in any form of an external data repository 804, either of which can be formatted into any one or more storage areas. Certain forms of computer readable media comprise parameterized storage 839 accessible by a key (e.g., filename, table name, block address, offset address, etc.).

Execution of the sequences of instructions to practice certain embodiments of the disclosure are performed by a single instance of a computer system 8A00. According to certain embodiments of the disclosure, two or more instances of computer system 8A00 coupled by a communications link 815 (e.g., LAN, public switched telephone network, or wireless network) may perform the sequence of instructions required to practice embodiments of the disclosure using two or more instances of components of computer system 8A00.

Computer system 8A00 may transmit and receive messages such as data and/or instructions organized into a data structure (e.g., communications packets). The data structure can include program instructions (e.g., application code 803) communicated through communications link 815 and communications interface 814. Received program instructions may be executed by data processor 807 as they are received at the data processor. The program instructions can be copied any number of times (e.g., into an intermediate memory and/or into a CPU cache) for later execution. Computer system 8A00 may communicate through a data interface 833 to a database 832. Data items in a database can be accessed using a primary key (e.g., a relational database primary key) and any number of secondary keys.

Processing element partition 801 is merely one sample partition. Other partitions can include multiple data processors and/or multiple communications interfaces and/or multiple storage devices, etc. within a partition. For example, a partition can bound a multi-core processor (e.g., possibly including embedded or co-located memory), or a partition can bound a computing entity having a plurality of computing elements, any of which computing elements are connected directly or indirectly to a communications link of any sort. Furthermore, a first partition can be configured to communicate to a second partition. A particular first partition and a particular second partition can be congruent (e.g., in a processing element array) or can be different (e.g., comprising disjoint sets of components). A partition can include a single module or a partition can include a plurality of modules.

As used herein, a module refers to any mix of any portions of system memory and any extent of hard-wired circuitry including hard-wired circuitry embodied as all or portions of a data processor 807, which data processor can be used to realize, with or without reliance on the system memory, all or portions of processor-implemented systems or subsystems. Some embodiments of a module include one or more special-purpose hardware components (e.g., sensors, transducers, power control, actuator control logic, etc.). Some embodiments of a module include instructions that are stored in a processor-accessible memory for execution so as to facilitate operational and/or performance characteristics pertaining to fitting a robotic system software stack to interface with an interstitial supervisory layer. A module may include one or more state machines and/or combinational logic used to implement or facilitate the operational and/or performance characteristics pertaining to fitting a robotic system software stack to interface with an interstitial supervisory layer.

Various implementations of database 832 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of fitting a robotic system software stack to interface with an interstitial supervisory layer). Such files, records, or data structures can be brought into and/or stored in volatile or non-volatile memory. The occurrence of, and organization of the foregoing files, records, and data structures improve the way in which the computer stores and retrieves data in memory so as to implement all or portions of a robotic system stack. Strictly as one example, various of the disclosed embodiments improve the way data is accessed when the computer is performing operations pertaining to fitting a robotic system software stack to integrate with an interstitial supervisory layer, and/or for improving the way data is manipulated when performing computerized operations pertaining to robot behavior.

FIG. 8B depicts an environment in which a behavior guarantee module can be implemented. As shown, environment 8B00 includes an example software library 816. Such a library can be situated in a development environment or such a library, either in whole or in part, can be deployed to the field for dynamic linking and loading. Strictly as one example, various components from such a software library can be interfaced together to form variations of a behavior guarantee module. Strictly as an illustration, a behavior guarantee module (e.g., example behavior guarantee module implementation 841) can be constructed of one or more environment interface modules 817, one or more component interface modules 821, one or more signal processing modules 825, and/or any one or more value processing modules 829. The foregoing environment interface modules, component interface modules, signal processing modules, and value processing modules are discussed in further detail hereunder.

As shown, environment interface modules 817 include a selectable set of environment sensor interface modules (e.g., environment sensor interface module 818₁, environment sensor interface module 818₂, . . . , environment sensor interface module 818_{N}; human I/O module 819₁, human I/O module 819₂, . . . , human I/O module 819_{N}; and artificial intelligence I/O module 820₁, artificial intelligence I/O module 820₂, . . . , artificial intelligence I/O module 820_{N}). Any of the foregoing constituents of the environment interface modules can be configured for any particular application. Any combination of environment interface modules can be juxtaposed in any topology and/or in any order or organization.

As shown, component interface modules 821 include a selectable set of component sensor modules (e.g., autonomy stack interface module 822₁, autonomy stack interface module interface module 822₂, . . . , autonomy stack interface module 822_{N}; and robotic control stack module 823₁, robotic control stack module 823₂, . . . , robotic control stack module 823_{N}). Any of the foregoing constituents of the component interface modules can be configured for any particular application. The component interface modules may further include a database or other storage of interface configuration specifications. Any combination of component interface modules can be juxtaposed in any manner.

As shown, signal processing modules 825 include a selectable set of various signal processing modules (e.g., signal conditioning module 826₁, signal conditioning module 826₂, . . . signal conditioning module 826_{N}; signal translation module 827₁, signal translation module 827₂, . . . signal translation module 827_{N}; and signal prioritization module 828₁, signal prioritization module 828₂, . . . , signal prioritization module 828_{N}). Any of the foregoing constituents of the signal processing modules can be configured for any particular application. Any combination of signal processing modules can be juxtaposed into any organization.

As shown, value processing modules 829 include a selectable set of various value processing modules (e.g., constraint processing module 830₁, constraint processing module 830₂, . . . constraint processing module 830_{N}; component health processing module 831₁, component health processing module 831₂, . . . , component health processing module 831_{N}; and system characterization module 840₁, system characterization module 840₂, . . . , system characterization module 840_{N}). Any of the foregoing constituents of the value processing modules can be configured for any particular application. Any combination of value processing modules can be juxtaposed into any organization. Moreover, in some settings, any of the foregoing modules and specifications can be included (or excluded) in any particular deployment.

The particular deployment shown includes an example supervisory layer implementation 872. Such a supervisory layer may include one or more implementations of a behavior guarantee module (e.g., the shown example behavior guarantee module implementation), which in turn may include one or more optimization problem solver (e.g., optimization problem solver implementation 843₁, and optimization problem solver implementation 843₂). A behavior guarantee module can be configured with any manner of environment interface modules, which in turn are configured to be able receive an ongoing stream of updated real-time condition signals 842. Those updated real-time condition signals can be combined with an ongoing stream of real-time constraint signals 855 to express a then-current safe operation requirement into codification that is in a form of a problem that can be solved by one or more optimization problem solvers.

The ongoing stream of real-time constraint signals 855 can derive from any combination of environmental safety constraints 850 and/or any combination of controllable condition safety constraints 849. In some cases, the ongoing stream of real-time constraint signals is output from a constraint calculation module 851. Such a constraint calculation module can be configured to process any combination of environmental condition signals 845 and/or any combination of robotic control system condition signals 846.

In many cases environmental condition signals can change in response to signals that are sent to the robotic controls. For example, consider the scenario where there is an obstacle (e.g., a stationary object or a moving object) on the trajectory or path of a movable mechanical device (e.g., a robotic manipulator, an autonomous robotic vehicle, an autonomous aerial drone, etc.). Supposing that the controllable condition safety constraints include a constraint that has the semantics of “stay at least 10 feet from any obstacle,” then the path of the movable mechanical device can be changed so as to “veer away” from the obstacle. Once the movable mechanical device has maneuvered away, the newly updated environmental condition signals might indicate that there is no longer an obstacle in the path (or close to the path) of the movable mechanical device. Now, further consider that the “veer away” action was taken because of the aforementioned environmental safety constraint. However, it might be that there is a currently in force controllable condition safety constraint 849 that has the semantics of “stay at least 20 feet from any obstacle,” in which case, when considering both the environmental safety constraints as well as the controllable condition safety condition constraints, the constraint calculation module might form a real-time constraint signal that is more restrictive (e.g., safer) than when considering environmental safety constraints alone.

In exemplary scenarios, real-time candidate robotic planning signals are considered with respect to real-time constraints (e.g., environmental safety constraints, controllable condition safety constraints, etc.) so as to produce safe real-time signals, which are then provided to various robotic control systems. More particularly, candidate robotic planning signals corresponding to a robotic operation or a manipulator movement, or a robotic vehicle maneuver can be modified in accordance with the foregoing techniques so as to generate real-time robotic control signals that are deemed to be safe.

Further details regarding general approaches to producing safe robotic vehicle maneuvers are described in U.S. application Ser. No. 18/324,042 titled “SYSTEMS AND METHODS FOR HIGH-SPEED GEOFENCING” filed on May 25, 2023, which is hereby incorporated by reference in its entirety.

There may be many other scenarios and many other types of environmental safety constraints 850 as well as many other types of controllable condition safety constraints 849. For example, it can happen that a particular controllable condition safety constraint might be less constraining than a corresponding environmental safety constraint. The optimization problem solvers would solve for optimal solutions that still satisfy the then-current safety constraints. As such, it can happen that optimal safe robotic behavior is not necessarily any less optimal in any regard than optimal robotic behavior even in the absence of any given controllable condition safety constraints. On the other hand, it frequently happens that observance of controllable condition safety constraints overrides mere environmental safety constraints so as to result in safe behavior of the robot.

The supervisory layer implementation of FIG. 8B is merely one example as is applicable to the shown example environment. A supervisory layer can be implemented in many alternative embodiments and/or environments, some of which such alternative embodiments and/or environments are shown and described as pertains to FIG. 8C1 and FIG. 8C2.

FIG. 8C1 depicts a block diagram of an interstitially situated supervisory agent. More specifically, FIG. 8C1 depicts block diagram 8C100 that includes a safety module 877 (e.g., constituting example supervisory agent 879) that is situated between a planning module 873 (e.g., comprising example autonomy stack implementation 870) and a kinetic control module 875 (e.g., comprising example robotic control stack implementation 874).

In this juxtaposition, the example supervisory agent implementation can be configured to (1) intercept signals from the example autonomy stack implementation, (2) process such intercepted signals, and (3) provide modified versions of the intercepted signals to downstream processing. Additionally or alternatively, the example supervisory agent 879 can be configured to receive and process signals from any one or more of a variety of environmental sources (e.g., from environmental condition sensors 878₁ and/or from environmental condition sensors 878₂).

In this illustrative example, downstream processing includes processing of the modified versions of the intercepted signals (e.g., by robotic control module 866₁, robotic control module 866₂, . . . , robotic control module 866_{N}) so as to provide signals to any of a plurality of motors 869 and/or actuators 868.

In this manner, the interstitially situated supervisory agent can support any one or more robotic control applications in various settings (e.g., involving robotic terrestrial vehicle control, manufacturing floor robot control, unmanned aerial vehicle control, anthropomorphic robot control, etc.). In this particular architecture, example supervisory agent 879 includes a signal intercept module 860, a signal modification module 862, and a signal data publisher module 856_{SAFETY}. The signal data publisher module 856_{SAFETY} is configured to enter modified versions of the intercepted signals (or portions thereof) into one or more modified signal queues, as exemplified by modified signal data queue array 859. As shown, the contents of the constituent queues of the modified signal data queue array (e.g., modified signal data queue entry MS₁₁, modified signal data queue entry MS₁₂, modified signal data queue entry MS₁₃, modified signal data queue entry MS₂₁, modified signal data queue entry MS₂₂, modified signal data queue entry MS₂₃, . . . , modified signal data queue entry MS_{N1}, modified signal data queue entry MS_{N2}, modified signal data queue entry MS_{N3}) are made accessible to downstream processing.

Strictly as one possible implementation, access to the contents of the constituent queues of the modified signal data queue array is facilitated by one or more subscriber modules. The shown example is security hardened by virtue of the communication protocol between shown signal subscriber module 864 and signal data publisher module 856_{SAFETY}, where such a communication protocol serves to securely communicate information (e.g., authentication credentials 857) between the modules.

The shown example robotic control stack implementation 874 includes a signal subscriber module, shown as signal subscriber module 864, which signal subscriber module can be configured to access entries that are stored in any one or more queues of the modified signal data queue array 859. In some cases, a signal subscriber module can be configured to access entries according to a first-in-first-out (FIFO) regime, and/or a signal subscriber module can be configured to access entries according to a last-in-first-out (LIFO) regime, and/or a signal subscriber module can be configured to access entries according to a random access regime, in which random access regime a subscriber can access entries from any position of any one or more queues of the modified signal data queue array.

Variations of the shown supervisory agent can be deployed in any environment that corresponds to any particular mission. Merely to illustrate one possible implementation, the environment of FIG. 8C1 includes a repository of mission-defining data structures 876. Particular types of data that might be populated into the foregoing mission-defining data structures may serve to inform various respective information collection and processing modules of an autonomy stack (e.g., information collection and processing module 852₁, information collection and processing module 852₂, . . . , information collection and processing module 852_{N}). These information collection and processing modules take in information from the environment (e.g., via environmental condition sensors 878₁) and process such environmental information in conjunction with data of the of mission-defining data structures so as to produce processed information in the form of signal data 854, which processed information is made available for publication to and access by any types of subscribers. As shown, a signal data publisher module 856_{AUTONOMY} is interfaced with signal data queue array 858 to provide access to signal data (e.g., as may be present in signal queue entry S11, signal data queue entry S₁₂, signal data queue entry S₁₃, signal data queue entry S₂₁, signal data queue entry S₂₂, signal data queue entry S₂₃, and signal data queue entry S_{N1}, signal data queue entry S_{N2}, . . . , signal data queue entry S_{N3}). Any signal data queue entry within the individual constituent queues of the signal data queue array 858 are accessible by signal intercept module 860. For security purposes, signal intercept module 860 may interact with signal data publisher module 856_{AUTONOMY} so as to establish authenticated and secure access to the content of the signal data queue array.

The foregoing example of FIG. 8C1 exemplifies an embodiment where the autonomy stack or its constituent autonomy agents publish signal data in a manner that the supervisory agent can intercept and process such signals. However there are situations where, rather than having an autonomy stack that generates signals destined for the robotic control stack, instead, a human operator generates signals destined for the robotic control stack. In similar fashion to how an interstitially situated supervisory agent can generate safe robotic control signals based on instructions from an autonomy stack, some embodiments generate safe robotic control signals based on instructions from a human operator. One example embodiment involving generating safe robotic control signals based on instructions from a human operator is shown and described as pertains to FIG. 8C2.

FIG. 8C2 depicts a block diagram involving a human operator's safe manipulation of a robotic control system. More specifically, FIG. 8C2 depicts block diagram 8C200 that includes an example supervisory agent 879 that is situated between an example human operators' environment 853 and an example robotic control stack implementation 874.

This figure is being presented to illustrate how a supervisory agent can produce safe robotic control system signals based on signals received from a human operator. In this particular example, operator 865 uses his or her senses to process any of a variety of environmental signals 867. As shown, the user processes visual signals, auditory signals and other sensory signals, and then, using human faculties, resolves such sensory signals into man-machine interface inputs. The shown human-machine interface 871 can accept any manner of real-time inputs (e.g., human-derived inputs 863) as well as any manner of settings 861 that the user establishes. In some cases, a particular instance of a human-machine interface receives information from a robotic control stack, which information can be used to calibrate the human-machine interface. Such calibration can take place statically (e.g., when the user is not actively providing human-derived signals to the human-machine interface), or such calibration can take place dynamically (e.g., during time periods when the user is actively providing human-derived signals to the human-machine interface).

As is known by those of ordinary skill in the art, a human operator can be a system's “own worst enemy.” That is, given a set of controls, and in absence of any modules that constrain or otherwise modify human inputs, a human operator, in spite of any amount of training and scenario simulation practice, can operate a robot in an unsafe manner. This of course is to be avoided. The foregoing supervisory agent serves to constrain or otherwise modify human inputs so as to guarantee safe operations with respect to all known environmental conditions. Strictly as one example, a supervisory agent can generate safe signals that govern speed of a manipulation and/or a supervisory agent can generate safe signals that govern the path taken (and safe space buffer required) by any articulation of the robot. There are many ways to implement safe signal generation and governance of a robotic system. On possible approach is shown and described as pertains to FIG. 8D.

FIG. 8D depicts a safe signal generation technique. The safe signal generation technique 8D00 is shown as a progression through several phases. In a first phase (e.g., the shown environmental situation prediction phase 881), an environmental situation prediction signal 882 is generated. In this example, the environmental situation prediction signal ranges from time=T₀ to time=T_{N}. The ordinate corresponds to the distance D that a robot is, or is predicted to be, from the nearest environmental features (e.g., the ground or obstacles that might be in the robot's path). In this particular scenario, the robot is initially at rest on the ground, traverses through a path, and comes again to a resting point on the ground.

In a second phase (e.g., the shown candidate robotic planning signal generation phase 883), a candidate planning signal 884 is generated. This candidate planning signal corresponds to the real-time signals that would need to be provided to the robotic control system in order to carry out a robotic operation or maneuver. In the illustrative example, the candidate planning signal already has some headroom or margin of error. Specifically, the candidate planning signal 884 corresponds to controlling the robot to maintain an even greater distance away from obstacles in the environment as was predicted in the environmental situation prediction phase 881. This is evident in the plot in that the candidate planning signal is plotted as maintaining an even greater distance away from any obstacle than is plotted by the environmental prediction signal. A candidate planning signal 884 may have within its range any number of local maxima and/or other types of critical points. In the shown example, there is a local maximum at time=T₁ and another local maximum at time=T₂.

After a candidate planning signal has been generated, possibly under control of an autonomy stack, the safe signal generation technique proceeds to a third phase (e.g., the shown safety constraint gathering phase 885) in which phase various safety constraints are gathered (e.g., from the shown controllable condition safety constraints 849). The specific constraints that are gathered (e.g., applicable safety constraints 889) may depend on whether or not a safe mode indication is enabled and/or whether an override mode indication is enabled, and may further depend on—and correspond to—any one or more of the then-current conditions. For example, if the currently under consideration maneuver requires movement through three dimensional space, then safety constraints corresponding to an X direction as well as safety constraints corresponding to a Y direction as well as safety constraints corresponding to a Z direction are gathered. Furthermore, in this safety constraint gathering phase, constraints pertaining to the mechanisms of the robotic control system are also gathered for potential use in the safety constraint application phase 887.

In most situations, accomplishment of some particular robotic maneuver involves control of actuators and/or control of motors. The operational characteristics of such actuators and/or motors is to be considered in the context of safety constraints. More specifically, application of any set of gathered safety constraints should not result in exceeding the operational capabilities of the robotic control mechanisms (e.g., actuators and/or motors). As an example, one way to avoid an obstacle is to “quickly maneuver” away from the obstacle when approaching it. However, in real robotic systems involving real motors and real actuators, operations intended to “quickly maneuver” are limited by characteristics that are designed into or inherent in the underlying robotic control system. Knowledge of such limitations are often pertinent to safe operation. To further explain, one way to “quickly maneuver” away from the obstacle so as to avoid a collision is to apply a great deal of acceleration in one or more directions that maneuver around or away from the obstacle. However, the amount of force needed to “quickly maneuver” might exceed the capabilities of the robotic control system. As such, safe operation needs to consider the limitations of the robotic control system when applying constraints.

After gathering applicable safety constraints in the safety constraint gathering phase 885, those gathered constraints can be applied. This is shown in FIG. 8D as a fourth phase, namely safety constraint application phase 887. In this phase, wrong or dangerous or practicably impossible robotic control signals are modified so as to operate within a safe robotic control regime. As can be seen, the transformation of the candidate planning signal 884 into the shown constrained candidate planning signal 888 serves to address any portions of the candidate planning signal 884 that were wrong or dangerous or practicably impossible, or otherwise unsafe. In the example signal transformation of FIG. 8D, the safe robotic control signal has some portions (e.g., within the impossible region) where the values in those portions correspond to lesser values than respective portions of the corresponding candidate planning signal (e.g., the portions as shown in the range of time=T₀ to time=T₁). Further, in the example signal transformation of FIG. 8D, the safe robotic control signal has some portions where the values in those portions correspond to higher values than respective points of the corresponding candidate planning signal (e.g., as shown in the range time=T₁ to time=T_{N}). In the example signal transformation of FIG. 8D, the safe robotic control signal has some portions where the values in those portions correspond to values that correct errors in respective points of the corresponding candidate planning signal (e.g., as shown in the range from time=T₃ to time=T_{N}).

In some cases, a particular incoming candidate planning signal is deemed to be safe even as unmodified (e.g., when the particular incoming candidate planning signal satisfies all applicable constraints). In other cases, a particular incoming candidate planning signal would need to be modified in order to be safe. In this latter case, any number of points and/or any number of ranges of points along the particular incoming candidate planning signal are modified to satisfy all applicable constraints. In the example shown, a particular range of points along the candidate planning signal 884, shown here as modified robotic planning signal range 886, are modified so as to send a ramped control signal (e.g., ramped during the time period from time=T₀ and time=T₁) to the robotic control system, rather than to apply an impulse signal to the robotic control system.

Of course the foregoing illustrates merely one type of situation. Other situations abound where some aspect of, or information from, the robotic control stack is used to inform how a candidate planning signal should be modified in order to produce a safe robotic control signal.

The foregoing techniques for guaranteeing safe behavior can be implemented in any environment and/or in any robotic system and/or in any deployment scenario. As a first example scenario, consider the situation where a first vehicle is approaching a second vehicle (e.g., in a speed/distance scenario where the first vehicle is a few seconds away from rear-ending the second vehicle. Now, assume unskilled driving where the driver accidentally presses the accelerator rather than the brake. In this situation, one or more safe behavior guarantee modules had prospectively characterized exactly how quickly the car is able to decelerate including consideration of characteristics of the vehicle's braking system, characteristics of the road, consideration of characteristics such as the weight of the vehicle and driver, as well as consideration of how much distance is covered during a braking maneuver. The one or more safe behavior guarantee modules calculates and actuates safe signals such that prior to a collision, the safe signals cause the first vehicle to decelerate (e.g., by applying brakes) on behalf of the driver. As a second example scenario, consider the situation where a robotic arm is repositioning a mechanical member from one position to another position. During the repositioning, a human being walks into the general proximity of the robotic arm. This presents a dangerous condition for the human being. As such, one or more safe behavior guarantee modules are configured to calculate safe parameters based on (1) the velocity (path and speed) of the human walking towards the robotic arm, as well as (2) how quickly the robotic arm can decelerate and stop. The one or more safe behavior guarantee modules use both pieces of information to intercept any unsafe reference signals that were intended to be sent to the robotic arm's actuators and motors. In addition to merely intercepting unsafe signals before they are sent to the robotic arm's actuators and motors, calculated signals are sent to the robotic arm's actuators and motors. As a third example scenario, consider the situation where a semi-autonomous mobile robot is moving around a factory floor. A maximum speed parameter indicates that the mobile robot is limited to less than 2 m/s speed. Now, if the operator instructs the robot accelerate to a speed of 3 m/s., then one or more safe behavior guarantee modules will intervene to intercept signals corresponding to the operator instructions and modify them down to the safe maximum speed of 2 m/s. This particular example might not require characterizing the dynamics of the semi-autonomous mobile robot since, if there is sufficiently accurate absolute position sensor data available (e.g., hi-resolution GPS data) the speed can be limited to the specified 2 m/s.

The foregoing discussion is presented here merely for illustrative purposes. The presence or absence of any particular feature in the drawings is not intended to be limiting. Moreover, the extent or scope of discussion of any particular feature or the absence of discussion of any particular feature is not intended to be limiting.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method for ensuring safe execution of robotic commands by a robot, the method comprising:
receiving a description of an environment;
forming a large language model (LLM) prompt to an artificial intelligence entity, wherein the prompt is based at least in part on the description of the environment;
responsive to prompting the artificial intelligence entity, receiving an LLM response that contains a dimension, or a limit, or a safety rating pertaining to aspects of the environment;
generating a plan for safe operation of the robot by:
classifying at least some portions of the LLM response;
labeling at least some sub-portions of the LLM response; and
based on the labeling, modifying at least some of the sub-portions to generate modified planning signals; and
providing the modified planning signals to the robot.

2. The method of claim 1, wherein classification of the at least some portions of the LLM response is carried out by a supervisory agent that receives robotic planning signals and produces the modified planning signals.

3. The method of claim 2, further comprising labeling portions of the robotic planning signals with a label that carries semantics of at least one of, a “do not approach” semantic, an “actively avoid” semantic, or a collision tolerant subrange.

4. The method of claim 2, wherein at least some portions of the LLM response are interpreted as referring to a false object that is deemed to be collision tolerant.

5. The method of claim 1, wherein at least some portions of the LLM response are interpreted using at least one of, natural language processing, or image processing.

6. The method of claim 1, wherein the description of the environment is given in one or more of, a textualized natural language description, an audible natural language description, or an image.

7. The method of claim 1, further comprising forming a further large language model prompt to the artificial intelligence entity, wherein the further large language model prompt is based at least in part on the LLM response.

8. The method of claim 1, further comprising forming a further large language model prompt to a further artificial intelligence entity, and wherein the further large language model prompt to the further artificial intelligence entity comprises at least one image.

9. The method of claim 8, wherein the further artificial intelligence entity operates in an image mode.

10. The method of claim 1, further comprising requesting the LLM to produce a response that includes one or more safe operation limits or one or more controllable condition safety constraints.

11. A non-transitory computer readable medium having stored thereon a sequence of instructions which, when stored in memory and executed by one or more processors causes the one or more processors to perform a set of acts for ensuring safe execution of robotic commands by a robot, the set of acts comprising:
receiving a description of an environment;
forming a large language model (LLM) prompt to an artificial intelligence entity, wherein the prompt is based at least in part on the description of the environment;
responsive to prompting the artificial intelligence entity, receiving an LLM response that contains a dimension, or a limit, or a safety rating pertaining to aspects of the environment;
generating a plan for safe operation of the robot by:
classifying at least some portions of the LLM response;
labeling at least some sub-portions of the LLM response; and
based on the labeling, modifying at least some of the sub-portions to generate modified planning signals; and
providing or the modified planning signals to the robot.

12. The non-transitory computer readable medium of claim 11, wherein classification of the at least some portions of the LLM response is carried out by a supervisory agent that receives robotic planning signals and produces the modified planning signals.

13. The non-transitory computer readable medium of claim 12, further comprising instructions which, when stored in memory and executed by the one or more processors causes the one or more processors to perform acts of labeling portions of the robotic planning signals with a label that carries semantics of at least one of, a “do not approach” semantic, an “actively avoid” semantic, or a collision tolerant subrange.

14. The non-transitory computer readable medium of claim 12, wherein at least some portions of the LLM response are interpreted as referring to a false object that is deemed to be collision tolerant.

15. The non-transitory computer readable medium of claim 11, wherein at least some portions of the LLM response are interpreted using at least one of, natural language processing, or image processing.

16. The non-transitory computer readable medium of claim 11, wherein the description of the environment is given in one or more of, a textualized natural language description, an audible natural language description, or an image.

17. The non-transitory computer readable medium of claim 11, further comprising instructions which, when stored in memory and executed by the one or more processors causes the one or more processors to perform acts of forming a further large language model prompt to the artificial intelligence entity, wherein the further large language model prompt is based at least in part on the LLM response.

18. The non-transitory computer readable medium of claim 11, further comprising instructions which, when stored in memory and executed by the one or more processors causes the one or more processors to perform acts of forming a further large language model prompt to a further artificial intelligence entity, and wherein the further large language model prompt to the further artificial intelligence entity comprises at least one image.

19. A system for ensuring safe execution of robotic commands by a robot, the system comprising:
a storage medium having stored thereon a sequence of instructions; and
one or more processors that execute the sequence of instructions to cause the one or more processors to perform a set of acts, the set of acts comprising, receiving a description of an environment;
forming a large language model (LLM) prompt to an artificial intelligence
entity, wherein the prompt is based at least in part on the description of the environment;
responsive to prompting the artificial intelligence entity, receiving an LLM response that contains a dimension, or a limit, or a safety rating pertaining to aspects of the environment;
generating a plan for safe operation of the robot by:
classifying at least some portions of the LLM response;
labeling at least some sub-portions of the LLM response; and
based on the labeling, modifying at least some of the sub-portions to generate modified planning signals; and
providing the modified planning signals to the robot.

20. The system of claim 19, wherein classification of the at least some portions of the LLM response is carried out by a supervisory agent that receives robotic planning signals and produces the modified planning signals.
